(19) United States
(12) Patent Application Publication
(10) Pub. No.: US 2007/0127367 A1
(43) Pub. Date: Jun. 7, 2007

(54) Communication system and communication method

(76) Inventors: Daisaku Ogasahara, Tokyo (JP); Masaki Umayabashi, Tokyo (JP); Nobuyuki Enomoto, Tokyo (JP); Youichi Hidaka, Tokyo (JP); Atsushi Iwata, Tokyo (JP); Akira Arutaki, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/579,484

(22) PCT Filed: Nov. 11, 2004
(86) PCT No.: PCT/JP04/17118

§ 371 Date: Aug. 2, 2006

(30) Foreign Application Priority Data
Nov. 17, 2003 (JP) 2003-387103

(51) Int. Cl. H04J 1/16; H04Q 7/00

(52) U.S. Cl. 370/226; 370/328

(57) ABSTRACT

A base node (100) and a base node (101) transmit a keep alive frame broadcast by a relay node forming a communication medium (106) and a communication medium (107) from a port 1 and a port 2, monitor an arrival state of the keep alive frame at each port, and in normal operation, assume the two communication media connected to the port 1 and the port 2 as one node to expand a communication band and at failure detection, continue communication by using only a communication medium connected to a port at which no failure is detected.

### FIELD OF THE INVENTION

The present invention relates to a communication system realizing high reliability and, more particularly, a communication system having high reliability which enables congestion to be suppressed by transmitting data frames by using a plurality of communication paths to expand a communication band in normal operation when no failure is detected and enables communication to be continued by using only a communication path with no failure detected when a failure is detected.

### DESCRIPTION OF THE RELATED ART

In recent years, computer networks have been introduced in every field in society to play an important social role not only as a communication means such as mutual understanding by electronic mail and information disclosure by a Web site but also as infrastructure for providing various kinds of services.

Today, when computer networks are indispensable for society, deep effects will be exercised on users by a situation that disables sufficient use of a communication system due to a failure of a device forming a network and due to reduction of a communication band caused by a fault such as cut-off of a communication cable and by congestion. Under these circumstances, there is an increasing demand for highly reliable computer networks having well-thought countermeasures against these network failures.

As a method of realizing a network having high reliability, commonly used is ensuring a plurality of communication paths in advance. When using the method, in normal operation when no failure occurs, a communication band is expanded by transmitting data dispersedly by a plurality of communication paths to reduce a possibility of occurrence of congestion. When a failure occurs, by transmitting data only to a communication path developing no fault, communication can be continued.

Various techniques have been conventionally proposed which realize the above-described method.

IEEE802.3ad (“Link Aggregation”, IEEE802.3ad, IEEE, 2000 (Literature 1)) as the standardization document issued by IEEE, for example, discloses a method of realizing improvement of failure-resistance and expansion of a communication band by using a technique called link aggregation.

In the link aggregation, with two adjacent nodes connected by a plurality of links, communication is executed assuming as if these plurality of links are a single link and even when any of these links develops a fault to disable communication, continuation of the communication is enabled by using other link having no fault.

Furthermore, in normal operation having no failure, transmitting a data frame by using a plurality of links enables a communication band of one link to be expanded to a multiple of the total number of links, thereby enabling a network to be established in which congestion is unlikely to occur.

Proposed as other techniques are methods using a routing protocol such as BGP (Border Gateway Protocol) disclosed in RFC1771 (Yakov Rekhter, Tony Li, “A Border Gateway Protocol 4 (BGP-4)”, RFC1771, IETF, 1995 (Literature 2)) which is the standardization document issued by IETF and OSPF (Open Shortest Path Fast) disclosed in RFC2328 (John Moy, “OSPF version 2”, RFC2328, IETF, 1998 (Literature 3)) which is also the standardization document issued by IETF.

According to such routing protocols, when detecting a failure occurring in a communication path, obtain a new communication path by a specific algorithm to switch a communication path to be used for communication from the communication path having the failure to the newly obtained communication path, thereby enabling communication to be continued even when a failure occurs. In addition, dispersedly communicating data by a plurality of communication paths prepared in advance enables expansion of a communication band as well.

Also proposed is a method using the NAT (Network Address Translator) technique which is disclosed in RFC1631 (Kjeld Borch Egevang, Paul Francis, “IP Network Address Translator”, RFC1631, IETF, 1994 (Literature 4)) which is the standardization document issued by IETF. By using the NAT technique and a means for detecting a failure in combination, data can be transferred by using a plurality of communication paths. Mainly used as a means for detecting a failure is a method of detecting a failure by arrival/non-arrival of a monitoring packet (e.g. PING packet) transmitted and received by nodes communicating with each other.

The above-described conventional methods, however, have the problems set forth in the following.

First is that the technique using link aggregation is only applicable to two nodes adjacent to each other and is not applicable to a network having various topology.

In a case, for example, where a plurality of different relay nodes exist on a communication path between two nodes communicating with each other and nodes adjacent to each other are connected by a plurality of links, adapting link aggregation provides each link between adjacent nodes with high reliability.

Even a link between adjacent nodes is given high reliability, however, just a fault such as a failure occurring in any one of the relay nodes on the communication path disables two nodes communicating with each other to communicate.

In addition, because link aggregation is applicable only between two nodes adjacent to each other, it is not applicable to a network in which two nodes communicating with each other are connected by a plurality of communication paths including at least one relay node.

Next, another problem is that, when using a routing protocol such as OSPF or BGP, detecting a failure on a communication path takes time, so that continuation of communication is disabled until detection of a failure.

Even when a failure is detected, a further problem occurs that because newly obtaining a communication path having no failure takes time, switching a communication path developing a fault to a communication path having no failure interrupts communication until communication is resumed.

Furthermore, since setting a routing protocol requires detailed and advanced knowledge about the routing protocol, setting is so difficult for a common user that a possibility of erroneous setting is increased to prevent efficient operation of a network.

Next, the technique of detecting a failure on a communication path by transmission and reception, by nodes communicating with each other, of a monitoring packet (e.g. PING packet) which designates a partner node as a destination, which is a failure detection technique used in combination with the NAT technique, has a problem that because as the number of partner nodes is increased, the number of monitoring packets to be transmitted is increased, load on processing for detecting a failure is extremely increased.

Further problem is that since a destination address of each of all the partner nodes should be set, the number of items to be set is increased as the number of partner nodes is increased, so that a possibility of erroneous setting by a manager of a network is increased.

### SUMMARY OF THE INVENTION

An object of the present invention, which takes the above-described problems of conventional techniques into consideration, is to provide a communication system realizing high reliability which enables, in a network having various topology in which a plurality of communication paths exist between base nodes communicating and a plurality of relay nodes exist on each communication path, occurrence of congestion to be suppressed in normal operation and enables communication to be continued even when a failure occurs.

Another object of the present invention is to provide a means for detecting a failure on a communication path between base nodes communicating in the above-described communication system.

A further object of the present invention is to provide a communication system whose setting is simple.

A still further object of the present invention is to provide a failure detection means having small load on a device.

In order to achieve the above-described objects, the present invention is characterized in that in a communication system with a plurality of base nodes communicating connected by a plurality of communication media formed of at least one relay node, the base node assumes the plurality of communication media as one node.

In addition, the present invention is characterized in that in the communication system, a communication band is expanded by transmitting a data frame by using a plurality of communication paths in normal operation and communication is continued by using only a communication path developing no fault when a failure is detected.

Furthermore, the present invention is characterized in that in the communication system, the base nodes transmit and receive a keep alive frame to/from each other and monitor an arrival state of a keep alive frame transmitted from a partner node to detect a failure.

Moreover, the present invention is characterized in that the keep alive frame has a destination address having the same effect as that of broadcast in the relay node forming the communication medium.

### BRIEF DESCRIPTION OF THE DRAWINGS

FIG. 1 is a diagram showing a structure of a communication system according to a first embodiment of the present invention;

FIG. 2 is a diagram showing another structure of the communication system according to the first embodiment;

FIG. 3 is a diagram showing a structure of a base node in the communication system according to the first embodiment;

FIG. 4 is a diagram showing a virtual port setting table;

FIG. 5 is a diagram showing a forwarding data base;

FIG. 6 is a diagram showing a communication state management data base;

FIG. 7 is a diagram showing a structure of a base node in a communication system according to a second embodiment of the present invention;

FIG. 8 is a diagram showing a port mapping table;

FIG. 9 is a diagram showing a forwarding data base;

FIG. 10 is a diagram showing a structure of a communication system according to a third embodiment of the present invention;

FIG. 11 is a diagram showing another structure of the communication system according to the third embodiment;

FIG. 12 is a diagram showing a structure of a base node in the communication system according to the third embodiment;

FIG. 13 is a diagram showing an address management data base;

FIG. 14 is a diagram showing a structure of a communication system according to a fourth embodiment of the present invention;

FIG. 15 is a diagram showing a structure of a base node in the communication system according to the fourth embodiment;

FIG. 16 is a diagram showing a structure of a base node in a communication system according to a fifth embodiment of the present invention;

FIG. 17 is a diagram showing a structure of a base node in a communication system according to a sixth embodiment of the present invention;

FIG. 18 is a diagram showing a port mapping table;

FIG. 19 is a diagram showing a forwarding data base;

FIG. 20 is a diagram showing another structure of the communication system according to the sixth embodiment;

FIG. 21 is a diagram showing a structure of a base node in a communication system according to a seventh embodiment of the present invention;

FIG. 22 is a diagram showing another structure of the base node in the communication system according to the seventh embodiment;

FIG. 23 is a diagram showing a forwarding data base;

FIG. 24 is a diagram showing a communication state management data base;

FIG. 25 is a diagram showing a frame format of an Ethernet (R) frame;

FIG. 26 is a diagram showing a frame format of an IP packet;

FIG. 27 is a diagram showing a forwarding data base;

FIG. 28 is a diagram showing an IP packet in which an Ethernet (R) frame is stored in a datagram;

FIG. 29 is a diagram showing an address management data base;

FIG. 30 is a diagram showing a frame format of an Ethernet (R) frame with a VLAN tag added;

FIG. 31 is a diagram showing a structure of a base node in a communication system according to an eighth embodiment;

FIG. 32 is a diagram showing a VLAN identifier setting table;

FIG. 33 is a diagram showing a data base for registering an IP address assigned to a base node with respect to a MAC address of a host and a real port for outputting an Ethernet (R) frame; and

FIG. 34 is a diagram showing a structure of a communication system according to a ninth embodiment of the present invention.

### DESCRIPTION OF THE PREFERRED EMBODIMENT

### First Embodiment

First embodiment of the present invention will be described in detail with reference to the drawings.

Structure of Communication System

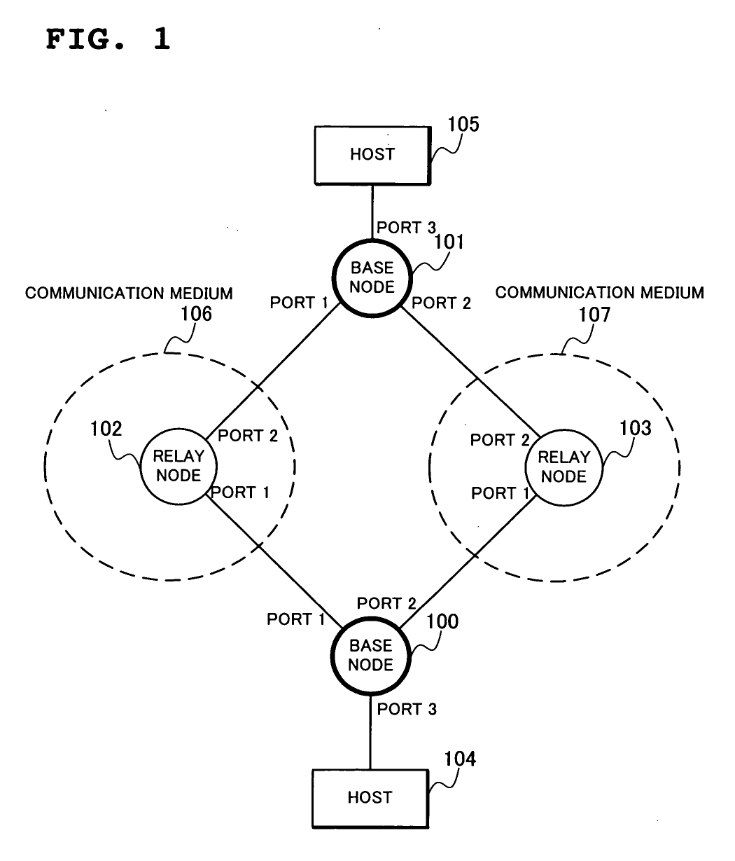

FIG. 1 shows a structure of a communication system according to the first embodiment of the present invention.

The communication system shown in FIG. 1 includes two base node 100 and base node 101, a communication medium 106 formed of a relay node 102, a communication medium 107 formed of a relay node 103, and two host 104 and host 105.

Here, the relay node, which is a node forming the communication medium, relays a data frame transmitted from the base node to transfer the same to a predetermined destination.

Base node, which is a node connected to the communication medium and has an arbitrary number of hosts accommodated in a port not connected to the communication medium among ports belonging to the base node directly or through at least one node, transfers a data frame transmitted from the host and the communication medium to a predetermined destination. In FIG. 1, to ports 3 of the base nodes 100 and 101, the hosts 104 and 105 are directly connected.

In the following description, a base node whose operation is noted will be referred to as an own-node and a base node other than an own-node will be referred to as a partner node. Being described simply as a node is assumed to represent a node in general including a relay node and a base node.

The base nodes 100 and 101 and the relay nodes 102 and 103 have a function as an Ethernet (R) switch which transfers a data frame of the Ethernet (R) (hereinafter referred to as an Ethernet (R) frame) transmitted from a certain transmission source to a predetermined destination.

The base nodes 100 and 101 can be realized by a computer having a network interface card mounted with the functions of the present invention which will be described in the following.

On such a computer as defined above, a plurality of network interface cards may be mounted each of which is connected to the individual communication media 106 and 107 or a single network interface card having a plurality of communication interfaces may be mounted each of which is connected to the communication media 106 and 107.

In a case where a plurality of network interface cards are mounted, an arbitrary number of communication media can be connected to each network interface card. In a case, for example, where two network interface cards are provided for three communication media, one communication medium can be connected to one network interface card and the other two communication media can be connected to the other network interface card.

In addition, the hosts 104 and 105 may be designed to be mounted with the function as the base nodes 100 and 101 of the present invention so as to be connected to the communication medium 106 and the communication medium 107 with none of the base nodes 100 and 101 provided therebetween.

To a port 1 of the base node 100 in FIG. 1, the communication medium 106 is connected, to a port 2, the communication medium 107 is connected, and to the port 3, the host 104 is connected.

In addition, to the port 1 of the base node 101, the communication medium 106 is connected, to the port 2, the communication medium 107 is connected, and to the port 3, the host 105 is connected.

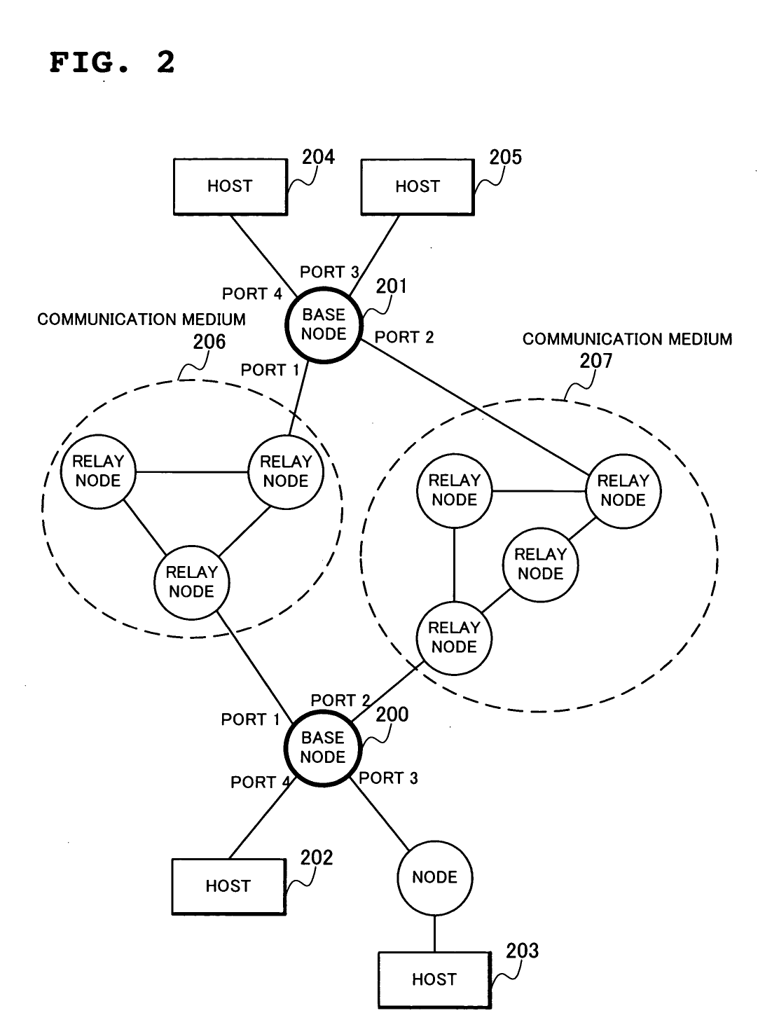

While to each of the base nodes 100 and 101 in FIG. 1, only one host is connected, two or more hosts can be connected by increasing the number of ports of a base node such as a base node 200 illustrated in FIG. 2 as other example of a structure of the communication system.

In addition, while the host 104 or the host 105 is directly connected to the base node 100 or the base node 101, it may be connected to the base node 200 through at least one node such as a host 203 in FIG. 2.

As a link connecting a base node and a communication medium and a link connecting a base node and a host, such links as Ethernet (R), ATM, a frame relay, ADSL, FTTH and ISDN can be used. Link speed of these links may vary with each link.

While in the communication system shown in FIG. 1, the two communication media are each formed of one relay node, they may be each formed of two or more relay nodes as in the communication system shown in FIG. 2.

Structure of Base Node

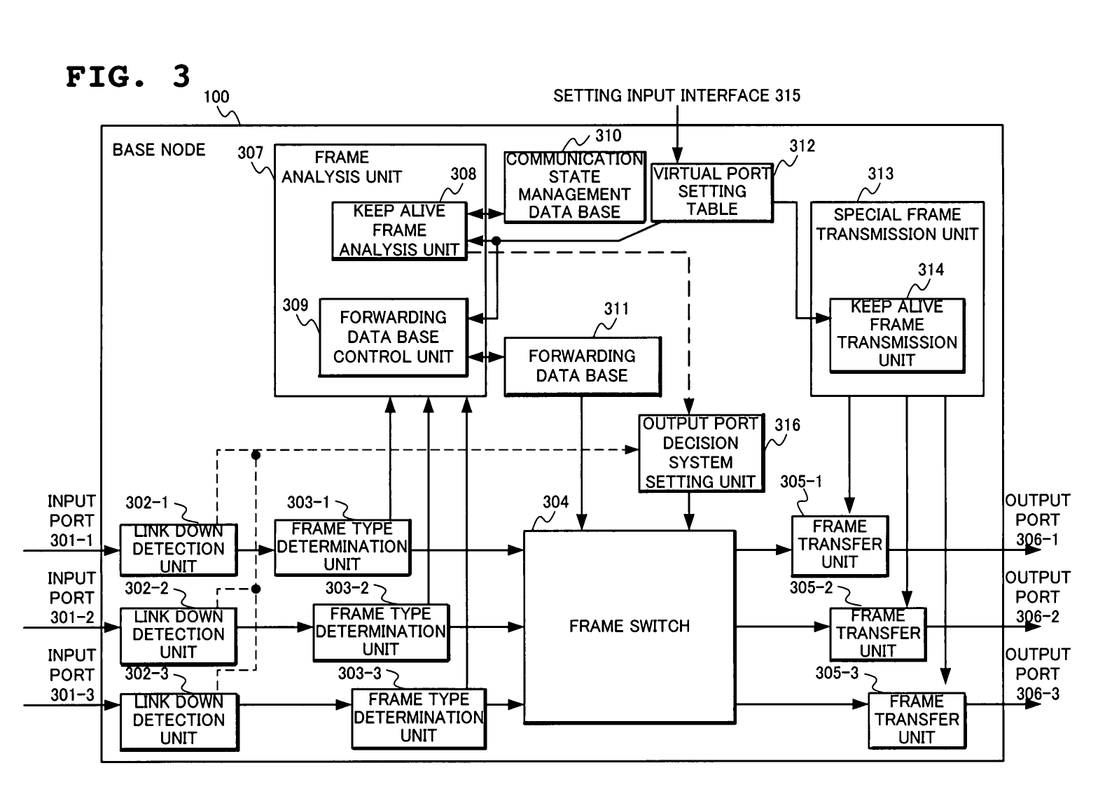

FIG. 3 is a block diagram showing a structure of the base node 100 in FIG. 1.

The base node 100 (also the case with the base node 101) shown in FIG. 3 includes input ports 301-1˜3 , link down detection units 302-1˜3 , frame type determination units 303-1˜3 , a frame switch 304, frame transfer units 305-1˜3 , output ports 306-1˜3 , a frame analysis unit 307 having a keep alive frame analysis unit 308 and a forwarding data base control unit 309, a communication state management data base 310, a forwarding data base 311, a virtual port setting table 312, a special frame transmission unit 313 having a keep alive frame transmission unit 314, a setting input interface 315 and an output port decision system setting unit 316.

The input ports 301-1˜3 of the base node 100 receive an Ethernet (R) frame transmitted from the host 104 or the relay nodes 102 and 103 and transfers the Ethernet (R) frame to the frame type determination units 303-1˜3. The input ports 301-1˜3 correspond to the ports 1 to 3 of the base node 100 or the base node 101, respectively.

When the Ethernet (R) frame is a keep alive frame, the frame type determination units 303-1˜3 transfer the Ethernet (R) frame to the keep alive frame analysis unit 308 and when the same is not a keep alive frame, transfer the Ethernet (R) frame to the forwarding data base analysis (*control?) unit 309 and the frame switch 304.

With reference to the forwarding data base 311, the frame switch 304 decides an output port of an Ethernet (R) frame based on an algorithm designated by the output port decision system setting unit 316 to transfer the Ethernet (R) frame to the frame transfer units 305-1˜3 .

At the output port decision system setting unit 316, an algorithm for the frame switch 304 to decide an output port is set. The output port decision system setting unit 316 is controlled by the keep alive frame analysis unit 308 and the link down detection units 302-1˜3 .

The frame transfer units 305-1˜3 transmit an Ethernet (R) frame transferred from the frame switch 304 and a keep alive frame transferred from the keep alive frame transmission unit 314 in the special frame transmission unit 313 through the output ports 306-1˜3. The output ports 306-1˜3 correspond to the ports 1 to 3 of the base node 100 or the base node 101, respectively.

The link down detection units 302-1˜3 monitor a link state of each port to control the output port decision system setting unit 316 based on the link state.

The forwarding data base 311 manages information for the frame switch 304 to decide an output port of an Ethernet (R) frame (destination node information and output port information).

The forwarding data base control unit 309 of the frame analysis unit 307 registers transmission source node information and input port information of a received Ethernet (R) frame in the forwarding data base 311.

The virtual port setting table 312, a table in which a port connected to a communication medium is set and stored in correlation as a virtual port, is set through the setting input interface 315 such as a keyboard or Telnet.

By assuming two ports set in the virtual port setting table 312 to be one port, the base node 100 is allowed to assume two communication media connected to the two ports set in the virtual port setting table 312 to be one node.

In the following, a port physically existing in a node will be described as a real port or a physical port and one virtual port corresponding to two real ports set in the virtual port setting table 312 will be described as a virtual port. Simply described as port is assumed to represent a real port.

In addition, two communication media assumed to be one node as a result of connection to a port set in the virtual port setting table 312 will be described as a virtual node.

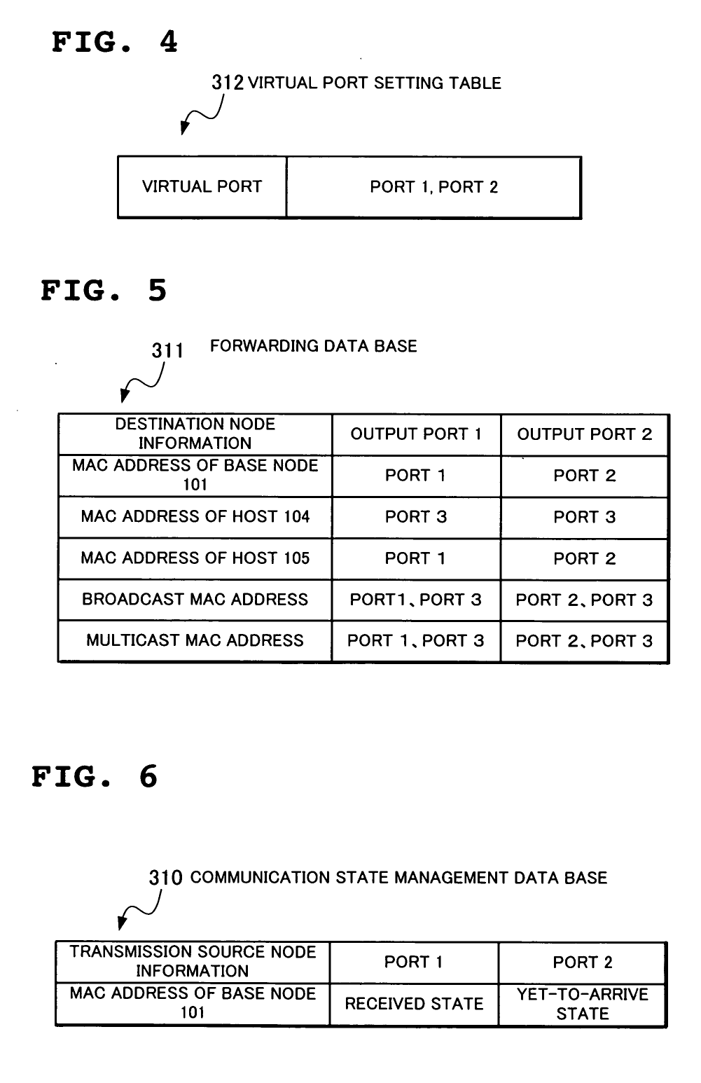

FIG. 4 shows one example of the virtual port setting table 312 in the base node 100.

In the virtual port setting table 312 shown in FIG. 4, the port 1 and the port 2 are set as one virtual port. This enables the base node 100 in FIG. 1 to handle the two communication media 106 and 107 connected to the port 1 and the port 2 as one virtual node connected to one virtual port.

The keep alive frame transmission unit 314 transmits a keep alive frame from a port set in the virtual port setting table 312.

The keep alive frame analysis unit 308 of the frame analysis unit 307 monitors a communication state according to a keep alive frame arrival state or the contents recited in the keep alive frame to control the output port decision system setting unit 316 based on a communication state.

The communication state management data base 310 is controlled by the keep alive frame analysis unit 308 to manage a keep alive frame arrival state for each partner node.

(Description of Operation)

(Outlines of Transfer of Ethernet (R) Frame)

Description will be made of operation executed when transmitting an Ethernet (R) frame directed to the host 105 from the host 104 in the communication system according to the present embodiment shown in FIG. 1.

The Ethernet (R) frame transmitted directed to the host 105 from the host 104 is received by the port 3 of the base node 100.

In normal operation when the base node 100 detects no failure, the base node 100 selects either the port 1 or the port 2 by using a specific algorithm which will be described later and transmits the Ethernet (R) frame from the selected port.

When transmitted from the port 1 of the base node 100, the frame is received at the port 1 of the base node 101 through the relay node 102. On the other hand, when transmitted from the port 2 of the base node 100, the frame is received at the port 2 of the base node 101 through the relay node 103.

The base node 101 transmits the Ethernet (R) frame received at the port 1 or the port 2 to the host 105 through the port 3.

When the base node 100 detects a failure not at the port 1 but at the port 2, for example, transmitting the Ethernet (R) frame transmitted from the host 104 only through the port 1 enables communication to be continued without interruption.

Thereafter, when detecting recovery from a failure at the port 2 of the base node 100, again transfer the Ethernet (R) frame by using either the port 1 or the port 2.

(Details of Ethernet (R) Frame Transfer)

Next, detailed description will be made of a procedure of creating the forwarding data base 311 to be referred to at the transfer of an Ethernet (R) frame and a procedure of transferring an Ethernet (R) frame in normal operation.

(Forwarding Data Base Creating Procedure)

In the following, a procedure of creating the forwarding data base 311 will be described.

The forwarding data base 311 is created by the forwarding data base control unit 309 and referred to by the frame switch 304 for deciding an output port of an Ethernet (R) frame.

An Ethernet (R) frame received at the input ports 301-1˜3 of the base node 100 (the port 1 to port 3 in FIG. 1) is transferred to the forwarding data base control unit 309 and the frame switch 304 by the frame type determination units 303-1˜3 .

When there exists no information related to a transmission source of the received Ethernet (R) frame in the forwarding data base 311, the forwarding data base control unit 309 registers a transmission source MAC address of the Ethernet (R) frame in destination node information (destination node identifier) of the forwarding data base 311 and registers an input port of the Ethernet (R) frame in output port information of the forwarding data base 311.

In the present embodiment, for assuming two real ports to be as one virtual port, two output port information, an output port 1 and an output port 2 can be registered for one destination node information of the forwarding data base 311.

When ports registered in the forwarding data base 311 are ports set in the virtual port setting table 312, one of two ports set in the virtual port setting table 312 is registered in the output port 1 and the other is registered in the output port 2.

In which of the output port 1 and the output port 2 the two ports set in the virtual port setting table 312 are to be registered is determined in advance so as to prevent ports registered in the output port 1 and the output port 2 from varying with destination node information of the forwarding data base 311.

Description will be made of a case, for example, where when the base node 100 receives an Ethernet (R) frame transmitted from the host 105 at the port 2, no information related to a transmission source of the received Ethernet (R) frame exists in the forwarding data base 311 and information related to the host 105 will be registered in the forwarding data base 311 with reference to the forwarding data base 311 of the base 100 shown in FIG. 5.

In the destination node information of the forwarding data base 311, a MAC address of the host 105 is registered.

In addition, since the port 2 as the input port of the Ethernet (R) frame is set in the virtual port setting table 312 of the base 100 shown in FIG. 4, register both of the port 1 and the port 2 registered in the virtual port setting table 312 in two output port information of the forwarding data base 311.

At this time, with the forwarding data base 311 in FIG. 5 designed in advance such that the port 1 is registered as the output port 1 and the port 2 is registered as the output port 2 of the output port information, registration is made as such in the output port information of the host 105 in FIG. 5.

When a port to be registered in the forwarding data base 311 is not set in the virtual port setting table 312, register the same port (the port 3 in the example shown in FIG. 5) in both the output port 1 and the output port 2.

Description will be made of a procedure, for example, of registering information related to the host 104 with reference to the forwarding data base 311 of the base 100 shown in FIG. 5.

Since an Ethernet (R) frame transmitted from the host 104 is received at the port 3 not registered in the virtual port setting table 312 in FIG. 4, the port 3 is registered as both the output port 1 and the output port 2 of the host 104.

Next, description will be made of registering, in the forwarding data base 311, information related to broadcast transfer and multicast transfer by which an Ethernet (R) frame is transmitted from one transmission source to a plurality of destinations.

Broadcast transfer and multicast transfer differ from unicast transfer by which an Ethernet (R) frame is transferred from a certain transmission source to one destination in that a plurality of ports are registered in output port information.

When broadcast-transferring or multicast-transferring an Ethernet (R) frame, in order to prevent the Ethernet (R) frame from looping, transmit the Ethernet (R) frame from other port than the input port of the Ethernet (R) frame among the ports registered in the output port information.

First, description will be made of a procedure of registering information related to broadcast transfer in the forwarding data base 311.

Register a broadcast MAC address in the destination node information of the forwarding data base 311.

In addition, in the output port 1 of the forwarding data base 311, register one of the two ports set in the virtual port setting table 312 and all the ports not set in the virtual port setting table 312.

In the output port 2 of the forwarding data base 311, the other of the two ports set in the virtual port setting table 312 and all the ports not set in the virtual port setting table 312 are registered.

Next, description will be made of a procedure of registering information related to multicast transfer in the forwarding data base 311.

Register a multicast MAC address in the destination node information of the forwarding data base 311.

In addition, in the output port 1 of the forwarding data base 311, register one of the two ports set in the virtual port setting table 312 and a port not set in the virtual port setting table 312.

In the output port 2 of the forwarding data base 311, register the other of the two ports set in the virtual port setting table 312 and a port not set in the virtual port setting table 312.

When registering information related to broadcast transfer or multicast transfer in the forwarding data base 311, in which of the output port 1 and the output port 2 the two ports set in the virtual port setting table 312 are to be registered is determined in advance so as to prevent ports registered in the output port 1 and the output port 2 from varying with each destination node information similarly to the above-described case of unicast.

While in the present embodiment, the description has been made of an example of registering output port information related to unicast transfer, broadcast transfer and multicast transfer in the forwarding data base 311, a plurality of forwarding data bases may be prepared for the respective transfer methods in order to refer to the forwarding data base 311 more rapidly.

(Transfer of Ethernet (R) Frame in Normal Operation)

In the following, description will be made of a procedure of transferring an Ethernet (R) frame by the base node 100 in an ordinary state (at the time of normal operation).

The frame switch 304 refers to the forwarding data base 311 to obtain output port information (the output port 1 and the output port 2) related to a destination MAC address of an Ethernet (R) frame transferred from the frame type determination units 303-1˜3.

When obtaining the output port information fails, refer to the output port information related to broadcast transfer in the forwarding data base 311.

Next, description will be made of a procedure of deciding an output port of an Ethernet (R) frame by the frame switch 304.

Since the frame switch 304 has different methods for deciding an output port of an Ethernet (R) frame in a case where a failure is detected and in a case where no failure is detected, it is designed to change an output port decision method by the setting of the output port decision system setting unit 316.

Description will be made of a case where as a method of deciding an output port of an Ethernet (R) frame by the frame switch 304, the following threes are defined:

(1) selecting either the output port 1 or the output port 2 by a specific algorithm,

(2) selecting the output port 1,

(3) selecting the output port 2.

As will be described later with respect to a failure detection procedure, when detecting no failure, the keep alive frame analysis unit 308 and the link down detection units 302-1˜3 set the method (1) in the output port decision system setting unit 316 and when detecting a failure, set the method (2) or (3).

More specifically, different numerical values should be assigned to the three methods to set an appropriate numerical value in the output port decision system setting unit 316 according to a failure detection condition.

The present embodiment is assumed to be designed to enable the frame switch 304 to change the method of deciding an output port by assigning the integer values “1”, “2” and “3” to the above-described methods (1), (2) and (3), respectively, and setting the integer values “1” to “3” in the output port decision system setting unit 316.

In the following, description will be made of a procedure of deciding a port through which an Ethernet (R) frame is output by the frame switch 304 in normal operation separately with respect to unicast transfer, broadcast transfer and multicast transfer.

First, description will be made of a procedure of unicast-transferring an Ethernet (R) frame in normal operation.

In normal operation when no failure is detected, the frame switch 304 decides an output port by the above-described method (1).

As an algorithm for selecting either the output port 1 or the output port 2, such an algorithm as round robin or weighting round robin can be used.

When using the weighting round robin, a weight assigned to each port can be set based on such a parameter as a link speed, a communication band or a delay between the base node 100 and the communication media 106 and 107.

It is also possible to employ a method of selecting an output port by executing hash by using information stored in a pay load of an Ethernet (R) frame such as header information of the Ethernet (R) frame including a destination MAC address and a transmission source MAC address or header information of an IP packet including a destination IP address and a transmission source IP address, or information combining these pieces of information.

Next, description will be made of a procedure of broadcast-transferring and multicast-transferring an Ethernet (R) frame in normal operation.

When an input port of an Ethernet (R) frame is set in the virtual port setting table 312, select, from the output port 1 and the output port 2, output port information including the input port for a reason which will be described below.

This is for preventing generation of a loop as a result of transmission of an Ethernet (R) frame to other port than the input port among the ports set in the virtual port setting table 312.

Description will be made, for example, of operation executed when the base node 100 receives a broadcast frame at the port 1 with reference to the forwarding data base 311 of the base 100 shown in FIG. 5.

In this case, the frame switch 304 selects the output port 1 including the port 1 as an input port of the broadcast frame to transfer the broadcast frame to all the ports (only the port 3 here) other than the input port.

Operation executed in a case where the input port of the Ethernet (R) frame is not set in the virtual port setting table 312 is the same as that in unicast transfer.

As described in the foregoing, when transferring an Ethernet (R) frame through a virtual port, dispersedly transmitting data frames to two ports set in the virtual port setting table 312 prevents a data frame from flowing concentratedly through one communication path to realize a highly reliable communication system in which congestion is very unlikely to occur.

(Transfer of Ethernet (R) Frame at Failure Detection)

Next, description will be made of a procedure of detecting a failure by the base nodes 100 and 101 and a procedure of transferring an Ethernet (R) frame when detecting a failure.

(Failure Detection by Keep Alive Frame)

In the following, a procedure of detecting a failure by the base node 100 will be described.

Description will be made of a procedure of detecting a failure of the base nodes 100 and 101, or a failure of the relay nodes 102 and 103 or a failure caused by cut-off of a link between the respective nodes by transmission and reception of a keep alive frame to/from the base nodes 100 and 101 shown in FIG. 1 with each other with reference to the drawing.

The base nodes 100 and 101 broadcast a keep alive frame through the two ports connected to the communication media 106 and 107, as well as receiving a keep alive frame transmitted from their partner node through the two ports connected to the communication media 106 and 107.

The base nodes 100 and 101 monitor an arrival state of the keep alive frame at each port which is transmitted from the partner node and detect the keep alive frame failing to arrive within a specific time period set in advance to detect occurrence of a failure.

When at a port at which a keep alive frame is yet to arrive, the keep alive frame again starts arriving within the specific time set in advance, the base nodes 100 and 101 determine that the failure is recovered.

In the following, description will be made of a procedure of detecting a failure by transmission/reception of a keep alive frame separately with respect to transmission of a keep alive frame and reception of a keep alive frame.

(Transmission of Keep Alive Frame)

First, a procedure of transmitting a keep alive frame by the base node 100 will be described.

The keep alive frame transmission unit 314 of the base node 100 repeatedly transmits a keep alive frame to a partner node through the two ports set in the virtual port setting table 312.

The shorter a time interval of transmitting a keep alive frame (specific time set in advance) becomes, the shorter time failure detection requires.

Here, detailed description will be made of a keep alive frame.

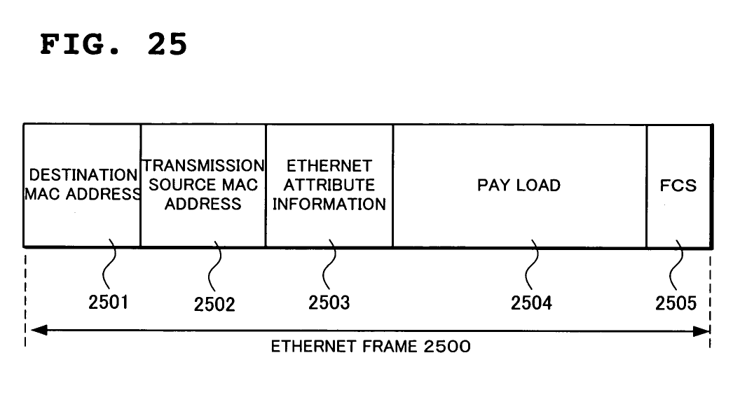

In the present embodiment, description will be made of a case where a keep alive frame is realized by using a data frame (Ethernet (R) frame 2500) having an Ethernet (R) frame format shown in FIG. 25.

Similarly to the description below, a keep alive frame can be realized also by using a data frame having other frame format than Ethernet (R).

In a destination MAC address 2501 of the keep alive frame, a MAC address having the equivalent effect in the relay nodes 102 and 103 to that of a broadcast MAC address is stored so as to enable the base nodes 100 and 101 to recognize the frame as a keep alive frame and enable the keep alive frame to be transferred to all the partner nodes.

Since in the present embodiment, only two base nodes exist, the base node 100 and the base node 101, to have no clear effect produced by broadcasting of a keep alive frame, a MAC address of a partner node may be stored in the destination MAC address 2501 of the keep alive frame.

However, because in the third and following embodiments which will be described later, a plurality of base nodes are connected to a communication medium, use of a MAC address having the equivalent effect to that of a broadcast MAC address attains an advantage of eliminating the need of transmission of a keep alive frame for each partner node.

As an example of the destination MAC address 2501 of a keep alive frame, such a MAC address can be used as enabling the relay nodes 102 and 103 to recognize the keep alive frame as an unknown unicast frame.

In the following, description will be made of a case where as the destination MAC address 2501 of a keep alive frame, such a MAC address is used as enables the relay nodes 102 and 103 to recognize a keep alive frame as an unknown unicast frame.

In a transmission source address 2502 of the keep alive frame, a MAC address of, for example, the base node 100 which transmits the keep alive frame is stored.

In Ethernet (R) attribute information 2503 of the keep alive frame, a data length or a type value of the keep alive frame is stored.

In a pay load 2504 of the keep alive frame, empty information equivalent to a minimum data length required for generating an Ethernet (R) frame is stored.

It is also possible to store information about a transmission source node of the keep alive frame or information about a communication state in the pay load 2504 to communicate between the base node 100 and the base node 101.

In an FCS 2505 of the keep alive frame, a value calculated by a predetermined calculation method is stored.

Here, description will be made of operation executed when a keep alive frame transmitted from the base node 100 is transferred to the base node 101 via the relay node 102 or the relay node 103 with reference to FIG. 1.

The base node 100 transmits a keep alive frame through the port 1 and the port 2 set in the virtual port setting table 312. The relay node 102 and the relay node 103 having received the keep alive frame at the port 1 transmit the keep alive frame through all the ports (port 2) other than the port 1 through which the keep alive frame is received because they recognize the keep alive frame as an unknown unicast frame. The keep alive frame broadcast by the relay node 102 and the relay node 103 is received by the port 1 and the port 2 of the base node 101.

This is also the case with operation executed when a keep alive frame transmitted from the base node 101 is transferred to the base node 100.

(Reception of Keep Alive Frame, Crecation of Communication State Management Data Base)

Next, a procedure that the base node 100 manages a keep alive frame arrival state by the communication state management data base 310 will be described.

In the following, description will be made of a keep alive frame arrival state defined as two states, a received state and a yet-to-arrive state.

Define a state from when a keep alive frame is received until a specific time set in advance elapses as a received state and a state where a keep alive frame is yet to be received even after a lapse of the specific time set in advance as a yet-to-arrive state. Define a state where a keep alive frame is never received also as a yet-to-arrive state.

When an arrival state of a keep alive frame transmitted from a certain partner node at a certain port goes to the yet-to-arrive state, the keep alive frame analysis unit 308 determines that there occurs a failure in the partner node, or a failure in a relay node on a communication path between the partner node and the port entering the yet-to-arrive state, or a failure caused by cut-off of a link between the respective nodes or the like.

The above-described specific time should be set taking into account that a keep alive frame transmission time interval and a keep alive frame propagation time are varied due to such an effect as a delay.

A keep alive frame received by the input ports 301-1˜3 of the base node 100 is transferred to the keep alive frame analysis unit 308 by the frame type determination units 303-1˜3.

In a case of manually setting the virtual port setting table 312 by the setting input interface 315 when the keep alive frame is received by a port not set in the virtual port setting table 312, the keep alive frame analysis unit 308 abandons the keep alive frame.

In a case of automatically setting the virtual port setting table 312, the keep alive frame analysis unit 308 automatically registers an input port of the keep alive frame in the virtual port setting table 312.

The latter case has an advantage of reducing a probability of erroneous setting by a network manager because just setting the virtual port setting table of either one of the base node 100 and the base node 101 in FIG. 1 enables setting of the virtual port setting table of the other.

The keep alive frame analysis unit 308 registers transmission source node information (e.g. a MAC address as an identifier of a base node as a partner node) of a received keep alive frame in the communication state management data base 310 which will be described later, as well as starting monitoring a state of arrival of the keep alive frame at the input port.

When the information related to the node already exists in the communication state management data base 310, update the contents to monitor the keep alive frame arrival state.

The communication state management data base 310 is a data base for managing an arrival state of a keep alive frame at all the ports set in the virtual port setting table 312 with respect to each transmission source node (partner node) of the keep alive frame.

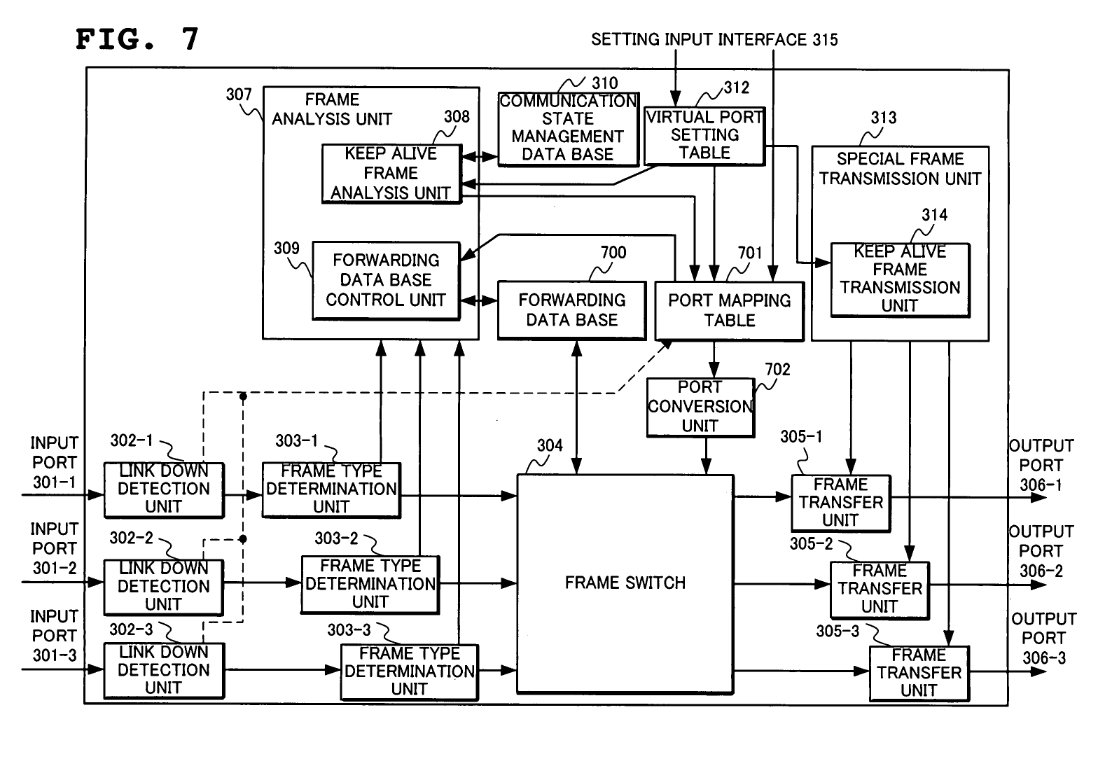

FIG. 6 shows one example of the communication state management data base 310 of the base node 100.

In the communication state management data base 310, as information indicative of a state of arrival at a port, “received state” or “yet-to-arrive state” is set corresponding to transmission source node information (e.g. a MAC address as an identifier of a base node as a partner node).

In the information indicative of the port arrival state for the transmission source node (base node 101) registered in the communication state management data base 310 shown in FIG. 6, the port 1 being in the “received state” represents that the port 1 is in a state before a specific time elapses after reception of the keep alive frame transmitted from the base node 101.

On the other hand, the port 2 being in the “yet-to-arrive” state represents that the port 2 has never received a keep alive frame transmitted from the base node 101 or fails to receive a keep alive frame transmitted from the base node 101 even after a lapse of the specific time after reception of a keep alive frame.

When information indicative of a port arrival state for the information related to a certain base node (the transmission source node information) all indicates the yet-to-arrive state in the communication state management data base 310, the keep alive frame analysis unit 308 determines that the base node is cut off from the communication system to delete the information related to the base node from the communication state management data base 310 and then stops monitoring an arrival state of a keep alive frame transmitted from the base node.

As described in the foregoing, a failure can be detected by monitoring an arrival state of a keep alive frame transmitted from a partner node.

(Transfer When Keep Alive Frame is Yet to Arrive)

Next, description will be made of a procedure of transferring an Ethernet (R) frame when the keep alive frame analysis unit 308 detects non-arrival of a keep alive frame.

When in the communication state management data base 310, an arrival state of a keep alive frame transmitted from a certain partner node goes to the yet-to-arrive state at one of two ports set in the virtual port setting table 312 and goes to-the received state at the other, the keep alive frame analysis unit 308 changes the value of the output port decision system setting unit 316 to “2” (to select the output port 1) or “3” (to select the output port 2) such that the frame switch 304 transfers an Ethernet (R) frame by using the output port information in which the port in the received state is registered among the two output port information in the forwarding data base 311.

For example, in the communication state management data base 310 shown in FIG. 6, the arrival state of a keep alive frame transmitted from the base node 101 is the received state at the port 1 and the yet-to-arrive state at the port 2.

Accordingly, the keep alive frame analysis unit 308 changes the value of the output port decision system setting unit 316 to “2” such that the frame switch 304 transfers the Ethernet (R) frame by using the output port 1 in which the port 1 is registered in the forwarding data base 311 in FIG. 5.

When in the communication state management data base 310, an arrival state of a keep alive frame transmitted from a certain partner node again goes to the received state at all the ports, the keep alive frame analysis unit 308 changes the value of the output port decision system setting unit 316 to “1” such that the frame switch 304 selects either the output port 1 or the output port 2 of the forwarding data base 311 by a specific algorithm to conduct transfer.

When in the communication state management data base 310, the arrival state of the keep alive frame transmitted from a certain partner node goes to the yet-to-arrive state at all the ports, the keep alive frame analysis unit 308 changes the value of the output port decision system setting unit 316 to “1” such that either the output port 1 or the output port 2 of the forwarding data base 311 is selected by a specific algorithm to conduct transfer similarly to the case of normal operation.

Alternatively, a special port number which makes an Ethernet (R) frame be abandoned may be registered in both the output port 1 and the output port 2 of an entry whose ports set in the virtual port setting table 312 are registered in the output port information of the forwarding data base 311.

Alternatively, an entry whose port set in the virtual port setting table 312 is registered in the output port information of the forwarding data base 311 may be deleted.

As described above, detecting a failure based on a keep alive frame arrival state to change the output port decision system setting unit 316 enables communication to be continued by using only a communication path in which no failure is detected.

Other than the above-described methods, it is possible to continue communication by using a method set forth below.

When in the communication state management data base 310, an arrival state of a keep alive frame transmitted from a certain partner node goes to the yet-to-arrive state at one of two ports set in the virtual port setting table 312 and goes to the received state at the other, the keep alive frame analysis unit 308 replaces the port in the yet-to-arrive state registered in the output port information of the forwarding data base 311 with the port in the received state.

Description will be made, for example, of operation executed when as shown in the communication state management data base 310 in FIG. 6, the arrival state of a keep alive frame transmitted from the base node 101 goes to the received state at the port 1 and the yet-to-arrive state at the port 2.

The keep alive frame analysis unit 308 replaces the port 2 registered in the output port 2 of the MAC address of the bas node 101, the MAC address of the host 105, the broadcast MAC address and the multicast MAC address with the port 1 in the forwarding data base 311 in FIG. 5.

At this time, the keep alive frame analysis unit 308 keeps the value of the output port decision system setting unit 316 be “1” (either the output port 1 or 2 is determined by a specific algorithm) without change.

As described in the foregoing, since changing the contents of the forwarding data base 311 prevents the port 1 whose failure is detected from being selected as an output port whichever of the output port 1 and the output port 2 is selected by the frame switch 304, the base node 100 is allowed to continue communication by using only the port 2 in which no failure is detected.

When in the communication state management data base 310, an arrival state of a keep alive frame transmitted from a certain partner node again goes to the received state at all the ports, the port replaced in the forwarding data base 311 should be changed from the port in the yet-to-arrive state to a port in the received state to restore the forwarding data base 311 to the original state.

When in the communication state management data base 310, an arrival state of a keep alive frame transmitted from a certain partner node goes to the yet-to-arrive state at all the ports, the same operation as in the above-described method of changing the output port decision system setting unit 316 should be executed.

As described above, detecting a keep alive frame arrival state and changing the forwarding data base 311 enables communication to be continued by using only a communication path in which no failure is detected.

(Transfer When Link Down is Detected)

Next, description will be made of operation executed when the link down detection units 302-1˜3 detect link down of a port.

When detecting link down in two ports set in the virtual port setting table 312, similarly to a case where a keep alive frame enters the yet-to-arrive state, the link down detection units 302-1˜3 change the value of the output port decision system setting unit 316 to “2” (to select the output port 1) or “3” (to select the output port 2) such that the frame switch 304 transfers an Ethernet (R) frame by using output port information failing to include the linked-down port among the two output port information of the forwarding data base 311.

When detecting link down in all the ports set in the virtual port setting table 312, the link down detection units 302-1˜3 change the value of the output port decision system setting unit 316 to “1” to select either one of the output port 1 and the output port 2 of the forwarding data base 311 by using a specific algorithm to execute transfer.

Alternatively, because communication using a port set in the virtual port setting table 312 is impossible, the frame switch 304 may abandon an Ethernet (R) frame whose output port is a port set in the virtual port setting table 312.

Alternatively, an entry whose port set in the virtual port setting table 312 is registered in the output port information of the forwarding data base 311 may be deleted.

Other than those described above, similarly to the Ethernet (R) frame transfer method executed when a keep alive frame is yet to arrive, communication can be continued using only a port in which no failure is detected, with the value of the output port decision system setting unit 316 set at “1”, by replacing a port in the forwarding data base 311 which enters the yet-to-arrive state with a port in the received state to select the port in the received state as an output port.

Since when a port links down, the keep alive frame analysis unit 308 detects a failure based on the non-arrival of a keep alive frame, the link down detection units 302-1˜3 are not always necessary.

However, while it takes a certain time for the keep alive frame analysis unit 308 to recognize the yet-to-arrive state of a keep alive frame, the link down detection units 302-1˜3 have advantages of being capable of coping with link down of a port quickly after its detection.

While in the first embodiment, the base node 100 is connected to the two communication media 106 and 107, increasing the number of output port information which can be registered in the forwarding data base 311 and increasing algorithms which can be designated by the output port decision system setting unit 316 enables application also to a communication system in which the base node 100 is connected to three or more communication media.

Description will be made, for example, of a communication system in which two base nodes are connected to three communication media.

In this case, it is only necessary to allow the forwarding data base to register three output port information of the output port 1, the output port 2 and the output port 3 and allow the output port decision system setting unit to designate the following seven algorithms according to a condition where a failure occurs.

(1) Select any one of the output ports 1 to 3 by a specific algorithm.

(2) Select either the output port 1 or the output port 2 by a specific algorithm.

(3) Select either the output port 2 or the output port 3 by a specific algorithm.

(4) Select either the output port 3 or the output port 1 by a specific algorithm.

(5) Select the output port 1.

(6) Select the output port 2.

(7) Select the output port 3.

As described in the foregoing, the method used in the present embodiment is applicable also to a case where the number of communication media to which a base node is connected is increased.

### Second Embodiment

Second embodiment of the present invention will be described in detail with reference to the drawings.

The second embodiment will be described with respect to a method of providing a highly reliable communication system by using a port mapping table.

(Structure of Communication System)

Since a structure of a communication system according to the second embodiment is the same as that of the communication system according to the first embodiment shown in FIG. 1, description thereof will be omitted.

(Structure of Base Node)

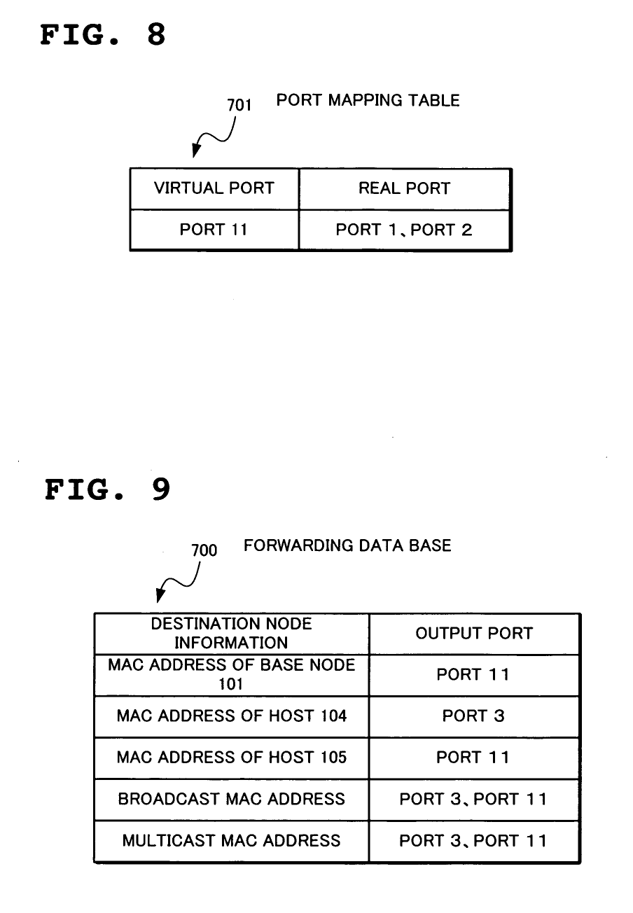

FIG. 7 is a block diagram showing a structure of the base nodes 100 and 101 according to the second embodiment.

The structure of the base node 100 (also the case with the base node 101) in the second embodiment differs from that of the first embodiment in that the base node 100 includes a port mapping table 701 and a port conversion unit 702.

By assigning, to a virtual port set in the virtual port setting table 312, a port number as information for unitarily identifying the virtual port, the port mapping table 701 enables the base node 100 to process a virtual port similarly to a real port.

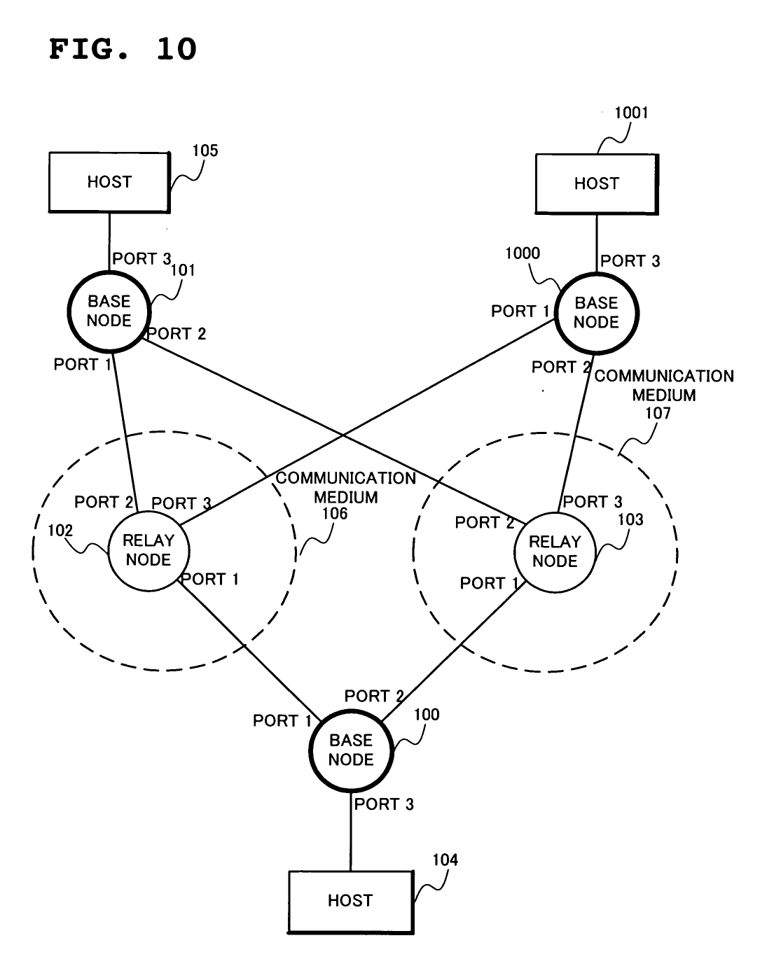

FIG. 8 shows one example of the port mapping table 701 of the base node 100.

In the port mapping table 701 in FIG. 8, to the virtual port in which the port 1 and the port 2 are registered in the virtual port setting table 312 in FIG. 4, a port 11 is assigned as a port number. By designating the port 11, the base node 100 is allowed to designate a virtual port.

The port conversion unit 702 converts a virtual port included in the output port information of a forwarding data base 700 into any one of two ports registered in the virtual port in the port mapping table 701.

In addition, the second embodiment differs from the first embodiment in that the link down detection units 302-1˜3 control the port mapping table 701 and the keep alive frame analysis unit 308 controls the port mapping table 701.

(Description of Operation)

In the following, description will be made of operation executed when an Ethernet (R) frame is transmitted directed to the host 105 from the host 104.

Since in the second embodiment, operation executed when the base node 100 in FIG. 1 transfers an Ethernet (R) frame directed to the host 105 which is transmitted from the host 104 is basically the same as that in the first embodiment, only different points will be described in the following.

(Creation of Forwarding Data Base)

First, description will be made of a procedure of creating the forwarding data base 700.

In the second embodiment, with the forwarding data base 700 having one output port information for one destination node information, a port number assigned to the virtual port in the port mapping table 701 is registered in the output port information of the forwarding data base 700.

FIG. 9 shows one example of the forwarding data base 700 of the base node 100.

For example, with reference to FIG. 9, description will be made of operation executed when registering information related to the host 104 and the host 105 in the forwarding data base 700.

Assume that in the virtual port of the base node 100, the port 1 and the port 2 are set as shown in the virtual port setting table 312 in FIG. 4.

Also, assume that in the virtual port, the port number 11 is assigned as shown in the port mapping table 701 in FIG. 8.

When the base node 100 receives an Ethernet (R) frame transmitted from the host 104 at the port 3, a MAC address of the host 104 is registered in the destination node information of the forwarding data base 700 and the port number 3 is registered in the output port information.

When the base node 100 receives an Ethernet (R) frame transmitted from the host 105 at the port 1, a MAC address of the host 105 is registered in the destination node information of the forwarding data base 700.

Since the port 1 as an input port of the Ethernet (R) frame is set in the virtual port of the virtual port setting table 312, it is converted into the port 11 assigned to the virtual port in the port mapping table 701 in FIG. 8 and registered in the output port information in the forwarding data base 700.

(Transfer of Ethernet (R) Frame in Normal Operation)

In the following, a procedure of transferring an Ethernet (R) frame in normal operation will be described.

The frame switch 304 refers to the forwarding data base 700 to obtain output port information related to a destination MAC address of an Ethernet (R) frame.

When acquisition of the output port information fails, obtain output port information related to broadcast transfer from the forwarding data base 700.

In the following, description will be made of a procedure of transferring an Ethernet (R) frame separately with respect to unicast transfer, broadcast transfer and multicast transfer.

First, unicast transfer of an Ethernet (R) frame will be described.

When a port registered in the output port information obtained with reference to the forwarding data base 700 is a virtual port, the frame switch 304 converts the virtual port into one real port registered in the port mapping table 701 by the port conversion unit 702 to transmit the Ethernet (R) frame through the converted real port.

Usable as an algorithm for selecting one real port by the port conversion unit 702 from among real ports registered in the port mapping table 701 is the algorithm used in the first embodiment when the frame switch 304 selects either one of the output port 1 and the output port 2 in the forwarding data base 700.

When the port registered in the output port information in the forwarding data base 700 is not a virtual port, transmit the Ethernet (R) frame through the port.

Description will be made, for example, of operation executed when the base node 100 transfers the Ethernet (R) frame directed to the host 105 with reference to FIG. 8 and FIG. 9.

With reference to the forwarding data base 700 in FIG. 9, the frame switch 304 obtains the port 11 as an output port. Since the port 11 is a virtual port, obtain a real port (the port 1 and the port 2) registered in the virtual port (port 11) with reference to the port mapping table 701 in FIG. 8. The frame switch 304 selects either the port 1 or the port 2 as an output port by a specific algorithm to transmit the Ethernet (R) frame through the selected port.

Next, description will be made of broadcast transfer or multicast transfer of an Ethernet (R) frame.

When a port registered in the output port information in the forwarding data base 700 includes an input port of the Ethernet (R) frame, in order to prevent generation of a loop, the frame switch 304 deletes the port from the output port information.

When the input port of the Ethernet (R) frame is a port registered in the port mapping table 701, execute the above-described processing after converting the input port into a virtual port.

When a port registered in the output port information of the forwarding data base 700 includes a virtual port, the frame switch 304 converts the virtual port into one real port by the port conversion unit 702 and then transmits the Ethernet (R) frame through all the ports registered in the output port information.

As described in the foregoing, by registering, in the output port information of the forwarding data base 700, a port number assigned to the virtual port in the port mapping table 701, an Ethernet (R) frame can be transferred through at least one real port registered in the virtual port in the virtual port setting table 312.

(Transfer of Ethernet (R) Frame at Failure Detection)

In the following, description will be made of a procedure of transferring an Ethernet (R) frame by the base node 100 when a failure is detected.

(Failure Detection by Keep Alive Frame)

In the present embodiment, since the procedure of detecting a failure by transmission/reception of a keep alive frame by the base node 100 is the same as that of the first embodiment, description thereof will be omitted.

(Transfer of Ethernet (R) Frame When Keep Alive Frame is Yet to Arrive)

Next, operation executed when an arrival state of a keep alive frame goes to the yet-to-arrive state will be described.

When the arrival state of a keep alive frame goes to the yet-to-arrive state at one of two ports set in the virtual port setting table 312 and to the received state at the other, the keep alive frame analysis unit 308 deletes the port entering the yet-to-arrive state from the port mapping table 701.

Description will be made, for example, of operation executed when the arrival state of a keep alive frame transmitted from the base node 101 goes to the yet-to-arrive state at the port 2 of the base node 100 with reference to the port mapping table 701 of the base node 100 shown in FIG. 8.

At this time, the keep alive frame analysis unit 308 deletes the port 2 from the port mapping table 701. Accordingly, only the port 1 is registered in the port mapping table 701.

When the port at which the arrival state of the keep alive frame is the yet-to-arrive state changes to the received state upon reception of a keep alive frame, the keep alive frame analysis unit 308 adds the port entering the received state to the port mapping table 701.

When the arrival state of the keep alive frame goes to the yet-to-arrive state at all the ports set in the virtual port setting table 312, set all the ports set in the virtual port setting table 312 at the port mapping table 701 similarly to the normal operation.

Alternatively, a special port number at which an Ethernet (R) frame is abandoned may be set in the port mapping table 701.

As described in the foregoing, the base node 100 is allowed to continue communication by registering only a port at which no failure is detected in the port mapping table 701.

(Transfer of Ethernet (R) Frame at Link Down Detection)

In the following, description will be made of operation when the base node 100 detects link down.

When the link down detection units 302-1˜3 detect a port being linked down, delete the linked down port from the port mapping table 701 similarly to a case where a keep alive frame enters the yet-to-arrive state.

Monitoring a link state of a port enables the port mapping table 701 to be changed more;quickly than recognition of the yet-to-arrive state of the keep alive frame by keep alive frame analysis unit 308.

As described in the foregoing, by employing the method of assigning a port number to a virtual port by the port mapping table 701 to register the port number of the virtual port in the output port information of the forwarding data base 700, a communication system having high reliability can be provided similarly to the first embodiment.

### Third Embodiment

Third embodiment of the present invention will be described in detail with reference to the drawings.

Third embodiment will be described with respect to a method of realizing high reliability in such a communication system as has a communication medium connected to three or more base nodes.

(Structure of Communication System)

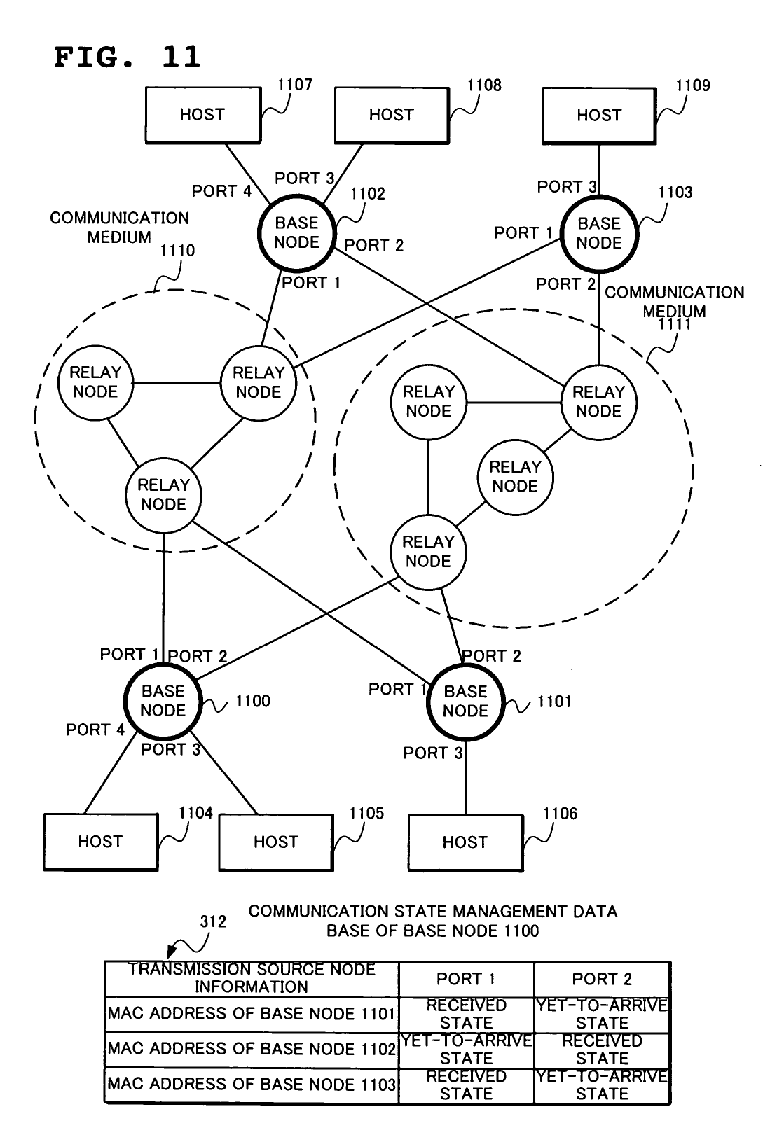

FIG. 10 shows a structure of a communication system according to the third embodiment.

The structure of the communication system according to the third embodiment differs from the first and second embodiments in that three base nodes 100, 101 and 1000 are connected to two communication medium 106 and communication medium 107. The base node 1000 is connected to the relay node 102 by the port 1, to the relay node 103 by the port 2 and to a host 1001 by the port 1(*3?).

While the communication system shown in FIG. 10 has the three, the base node 100, the base node 101 and the base node 1000 connected to the communication media 106 and 107, it may be a communication system having an arbitrary number, two or more, of the base nodes connected to the communication media 106 and 107.

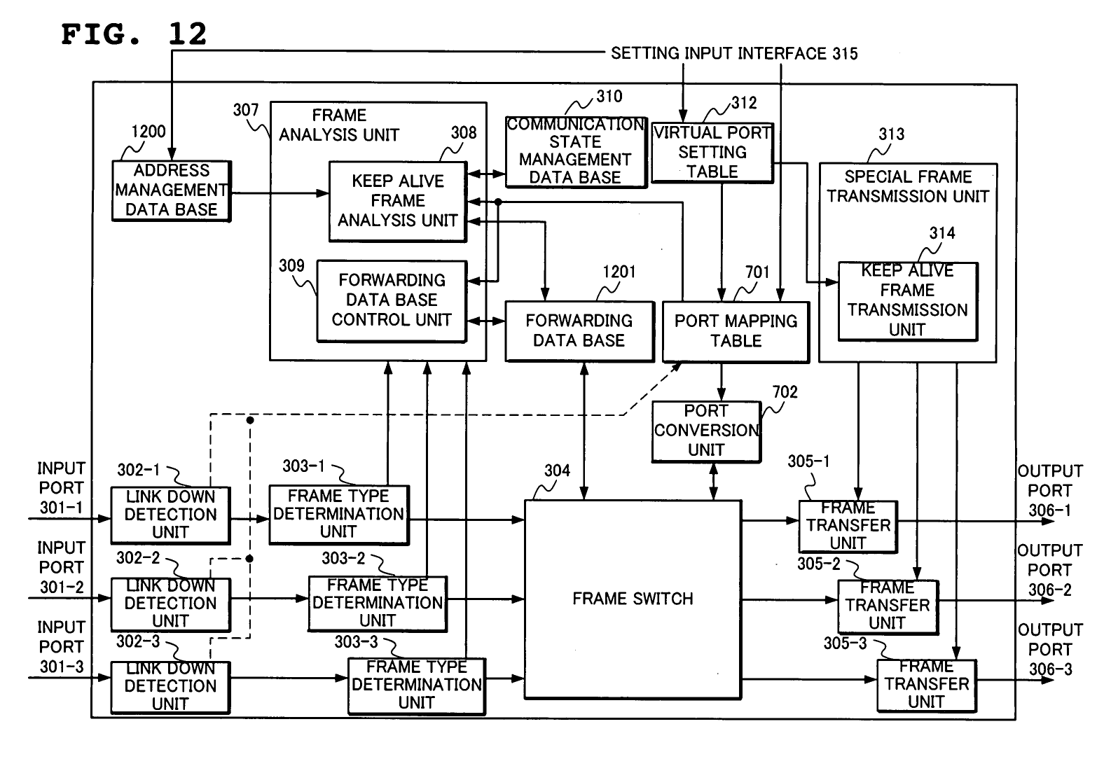

In addition, while in the communication system shown in FIG. 10, the communication media 106 and 107 are each formed of one relay node, they may be formed of a plurality of relay nodes as the communication system shown in FIG. 11.

(Structure of Base Node)

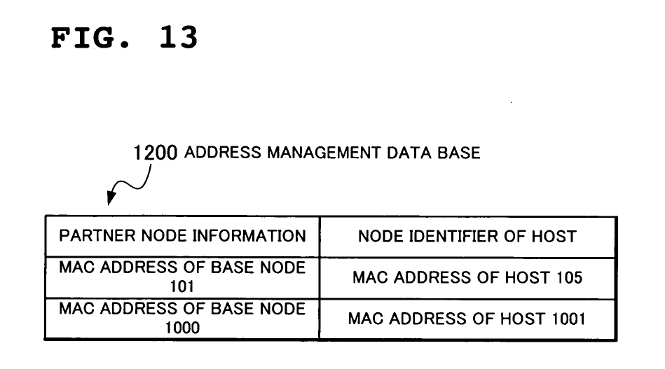

FIG. 12 is a block diagram showing a structure of the base node 100, the base node 101 and the base node 1000 according to the third embodiment.

The structure of the base node 100 (also the case with the base nodes 101 and 1000) in the third embodiment differs from the structure according to the second embodiment in including an address management data base 1200.

The address management data base 1200 manages a corresponding relationship between all the hosts connected directly or through at least one node to a port not connected to the communication media 106 and 107 among the ports belonging to a partner node and the partner node.

In the present embodiment, the address management data base 1200 is manually set by using the setting input interface 315 such as a keyboard or Telnet.

FIG. 13 shows one example of the address management data base 1200 of the base node 100. Here, corresponding to a MAC address of the base node 101 and a MAC address of the base node 1000 as partner node information of the base node 100, MAC addresses of the host 105 and the host 1000 as node identifiers are set.

It is found from the address management data base 1200 in FIG. 13 that the host 105 is connected to the base node 101 and the host 1001 is connected to the base node 1000.

In addition, the third embodiment differs from the second embodiment in that the keep alive frame analysis unit 308 controls a forwarding data base 1201.

(Description of Operation)

In the following, description will be made of a procedure of transferring an Ethernet (R) frame from the host 104 to the host 105.

(Transfer of Ethernet (R) Frame in Normal Operation)

Since in the third embodiment, the procedure of transferring an Ethernet (R) frame directed to the host 105 which is transmitted from the host 104 by the base node 100 in normal operation is the same as that of the second embodiment, description thereof will be omitted.

(Transfer of Ethernet (R) Frame in Failure Detection)

In the following, description will be made of operation of transferring an Ethernet (R) frame directed to the host 105 which is transmitted from the host 104 by the base node 100 when a failure is detected.

Since in the third embodiment, the procedure of detecting a failure by transmission/reception of a keep alive frame is the same as that of the first embodiment, description thereof will be omitted.

(Transfer of Ethernet (R) Frame When Keep Alive Frame is Yet to Arrive)

Next, description will be made of operation executed when the arrival state of a keep alive frame goes to the yet-to-arrive state.

When in the communication state management data base 310, the arrival state of the keep alive frame goes to the yet-to-arrive state at one of two ports set in the virtual port setting table 312 and goes to the received state at the other, the keep alive frame analysis unit 308 replaces a virtual port registered in the output port information of the forwarding data base 1201 which will be described later with a real port in the received state.

The above-described replacement processing should be executed only with respect to the information of the forwarding data base 1201 related to communication of all the hosts connected to a transmission source node of a keep alive frame entering the yet-to-arrive state.

More specifically, execute the above-described processing with respect to output port information of the transmission source node whose keep alive frame enters the yet-to-arrive state, output port information related to a host correlated with the transmission source node by the address management data base 1200, output port information related to broadcast transfer and output port information related to multicast transfer.

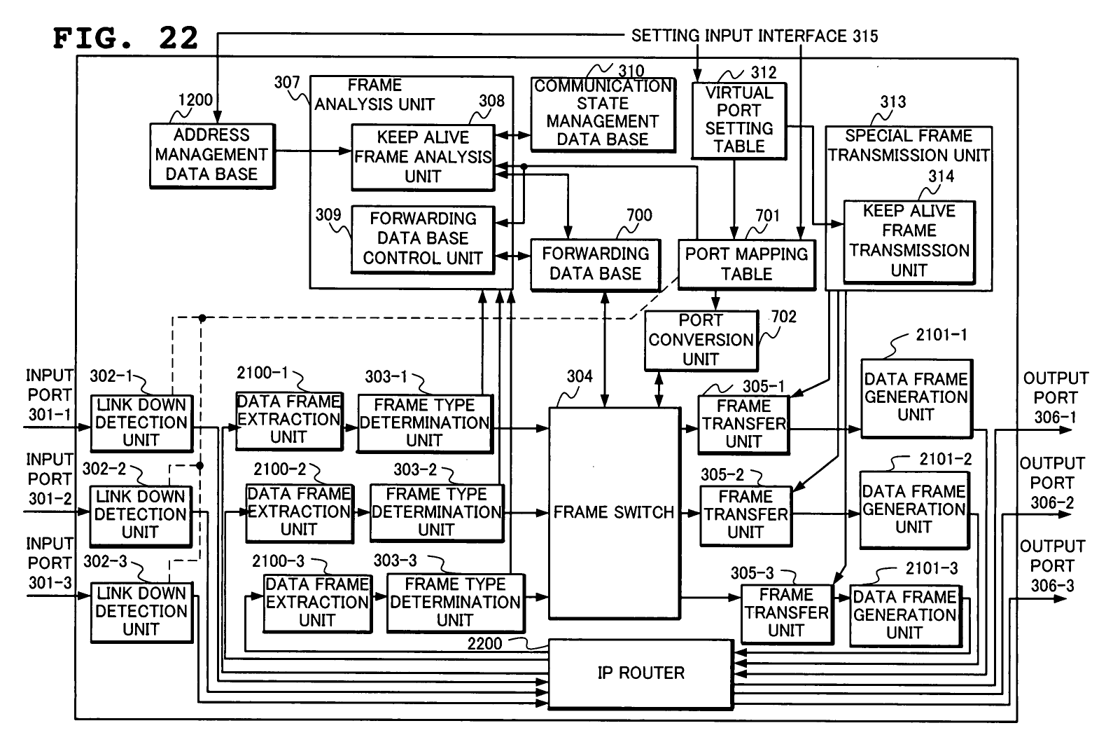

Description will be made, for example, of a case where a keep alive frame transmitted from the base node 101 enters the received state at the port 1 and the yet-to-arrive state at the port 2 with reference to the forwarding data base 1201 of the base node 100 shown in FIG. 23.

The keep alive frame analysis unit 308 of the base node 100 replaces the port 11 in the virtual port registered in the output port information of the base node 101 with the port 1 in the received state in the forwarding data base 1201 in FIG. 23.

In addition, execute the same processing as the above-described processing also with respect to output port information corresponding to the host 105 correlated to the base node 101 by the address management data base 1200 of the base node 100, the broadcast MAC address and the multicast MAC address among the output information of the forwarding data base 1201.

When the arrival state of a keep alive frame transmitted from a certain partner node changes from the yet-to-arrive state at one of two ports set in the virtual port setting table 312 and the received state at the other to the received state at both the ports, the keep alive frame analysis unit 308 replaces a port set in the virtual port setting table 312 among the ports registered in the output port information of the forwarding data base 1201 with a virtual port.

In the above-described example, when a keep alive frame transmitted from the base 101 is again received at the port 2 of the base node 100, the base 100 replaces the port 1 registered in the output port information of the base node 101 in the forwarding data base 1201 with the port 11 in the virtual port.

When the arrival state of the keep alive frame transmitted from a certain partner node goes to the yet-to-arrive state at all the ports set in the virtual port setting table 312, the keep alive frame analysis unit 308 deletes information related to the partner node from the communication state management data base 310 to stop monitoring the arrival state of the keep alive frame transmitted from the partner node as described above.

Alternatively, among the ports registered in the output port information of the forwarding data base 1201, a port set in the virtual port setting table 312 may be replaced with a virtual port.

Alternatively, it may be replaced by a special port number by which the Ethernet (R) frame is abandoned.

While the above-described state satisfies conditions of a multilink failure which will be described later, it is assumed not to be considered a multilink failure as will be described with respect to operation at multilink failure detection.

As described in the foregoing, detecting a failure based on non-arrival of a keep alive frame transmitted from a partner node to replace a virtual port registered in the output port information of the forwarding data base 1201 by a port having no failure detected enables communication to be continued using a communication path in which no failure is detected.

(Transfer of Ethernet (R) Frame at Link Down Detection)

Since in the third embodiment, the operation executed when the link down detection units 302-1˜3 detect link down of a port is the same as that of the second embodiment, description thereof will be omitted.

(Broadcast Transfer and Multicast Transfer at Multilink Failure Detection)

In the following, description will be made of operation executed when the keep alive frame analysis unit 308 detects a multilink failure which will be described later.

Multilink failure is defined as a state where in the communication state management data base 310, a keep alive frame of an arbitrary partner node enters the yet-to-arrive sate at all the ports set in the virtual port setting table 312.

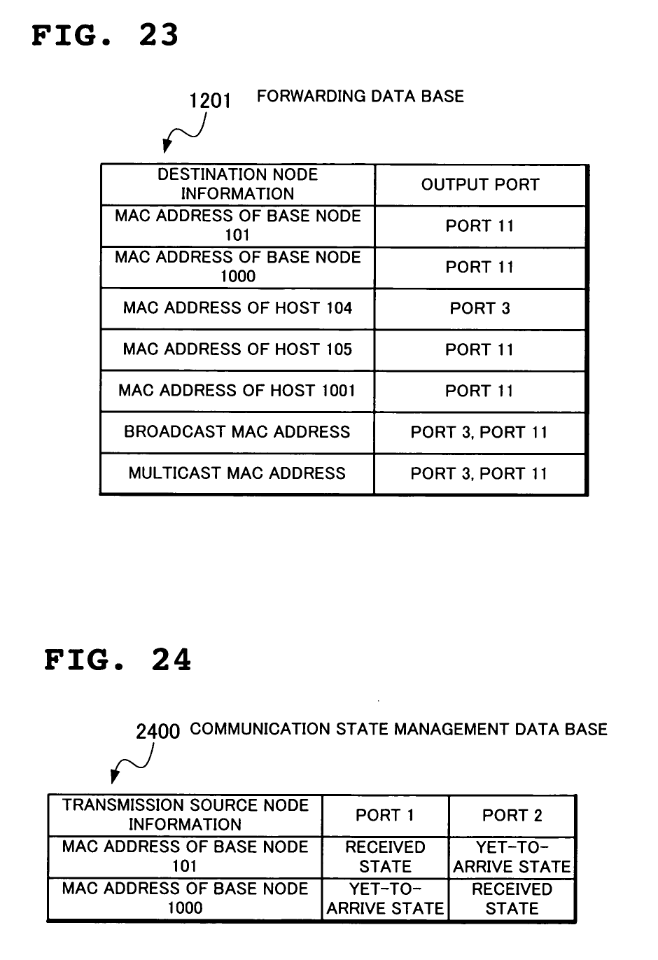

Description-will be made, for example, of detection of a multilink failure with reference to a communication state management data base 2400 of the base node 100 shown in FIG. 24.

In the communication state management data base 2400 shown in FIG. 24, the keep alive frame of the base node 1000 is in the yet-to-arrive state at the port 1 and the keep alive frame of the base node 101 is in the yet-to-arrive state at the port 2.

The base node 100 determines that a multilink failure occurs because at all the ports (the port 1 and the port 2) set in the virtual port setting table 312 shown in FIG. 4, the yet-to-arrive state of a keep alive frame is detected.

Although when the arrival state of a keep alive frame transmitted from a certain partner node goes to the yet-to-arrive state at all the ports set in the virtual port setting table 312, conditions of a multilink failure are satisfied, because information related to the partner node will be soon deleted from the communication state management data base 310 by the keep alive frame analysis unit 308 to fail to satisfy the conditions of a multilink failure, this case is assumed not to be considered a multilink failure.

When a multilink failure occurs, such problems as set forth below will arise.

Description will be here made of a case where when a link between the base node 101 and the relay node 103 and a link between the base node 1000 and the relay node 102 shown in FIG. 10 are cut off, the base node 100 detects such a multilink failure as shown in the communication state management data base 2400 in FIG. 24.

At this time, when the base node 100 receives a broadcast frame transmitted from the host 104 at the port 3 and broadcast-transfers the same, transmitting a broadcast frame to either one of the port 1 and the port 2 set in the virtual port setting table 312 in FIG. 4 causes a problem that a broadcast frame can be transferred to either one of the base node 101 and the base node 1000.

Also when the output port information of a certain multicast MAC address includes a virtual port or a port set in the virtual port setting table 312, the same problem as in broadcast frame transfer arises.

In order to solve the above-described problem, when a multilink failure is detected, it is necessary to transmit a broadcast frame or a multicast frame through all the ports set in the virtual port setting table 312.

Accordingly, when detecting a multilink failure, the keep alive frame analysis unit 308 adds all the ports set in the virtual port setting table 312 to the output port information related to broadcast transfer in the forwarding data base 1201.

Also as to the output port information related to a multicast MAC address with respect to which the same problem occurs, execute the same processing as that of the output port information related to broadcast transfer.

When in a communication system having four or more base nodes, a certain base node detects a multilink failure to transmit a broadcast frame through all the ports set in the virtual port setting table 312, however, there arises a problem that a partner node receives the broadcast frame twice.

Description will be made of a case, for example, where in the communication system shown in FIG. 11, a link between a base node 1101 and a communication medium 1111 and a link between a base node 1102 and a communication medium 1110 are cut off, so that a base node 1100 detects such a multilink failure as shown in the communication state management data base 310.

When the base node 1100 broadcasts a broadcast frame transmitted from a host 1104 to both the port 1 and the port 2, a base node 1103 will receive a broadcast frame twice at both the port 1 and the port 2 in the received state.

In order to solve the above-described problem, at multilink failure detection, the base node 1103 receives a broadcast frame only at one of the two ports set in the virtual port setting table 312 and abandons a broadcast frame at the other.

As to a broadcast frame input to either one of the ports set in the virtual port setting table 312, for example, allow reception to execute transfer processing and as to a broadcast frame input to the other port, abandon the same.

As a port at which reception is allowed, a port at which a keep alive frame enters the yet-to-arrive state least frequently or a port whose port number is the lowest should be used in the communication state management data base 310.

However, since a broadcast frame transmitted from a partner node in which a keep alive frame is yet to arrive at a port allowed to receive a broadcast frame and from all the hosts correlated with the partner node in the address management data base 1200 is input to a port not allowed of reception, as to a broadcast frame transmitted from such a partner node and host, allow reception at a port not allowed of reception to execute transfer processing.

Description will be made of the above-described processing executed when the base node 100 in FIG. 10 detects such a multilink failure as shown in the communication state management data base 2400 in FIG. 24.

The base node 100 allows reception of a broadcast frame only at the port 1 to execute transfer processing and abandons a broadcast frame received at the port 2.

As to a broadcast frame transmitted from the base node 101 and a host correlated with the base node 101 in the address management data base 1200, however, allow reception at the port 2 to execute transfer processing.

As described in the foregoing, a communication system having high reliability can be provided even when there exist three or more base nodes which communicate with each other.

### Fourth Embodiment

Fourth embodiment of the present invention will be described in detail with reference to the drawings.

The fourth embodiment will be described with respect to a method of reducing load on setting of an address management data base by a network manager by placing a router between a base node and a host.

(Structure of Communication System)

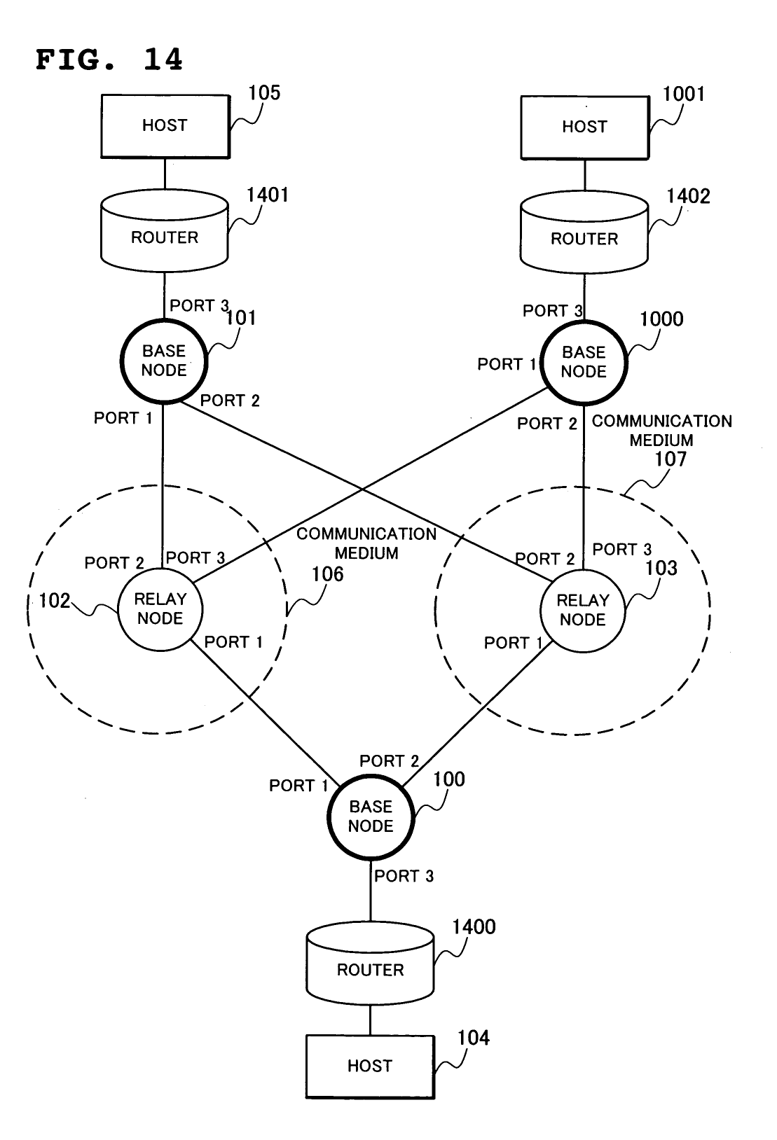

FIG. 14 shows a structure of a communication system according to the fourth embodiment.

The structure of the communication system according to the fourth embodiment differs from that of the third embodiment in that between the base nodes 100, 101 and 1000 and the hosts 104, 105 and 1001, routers 1400, 1401 and 1402 are placed, respectively.

In the present embodiment, although the base node and the router are separate devices, the functions of the base node and the router can be built in.

Since in the fourth embodiment, a transmission source MAC address of an Ethernet (R) frame transmitted from a host is changed to a MAC address of a router by the router and transferred, it is not necessary to manage all the hosts connected to a partner node as in the third embodiment and it is necessary to manage only a router connected to the partner node.

(Structure of Base Node)

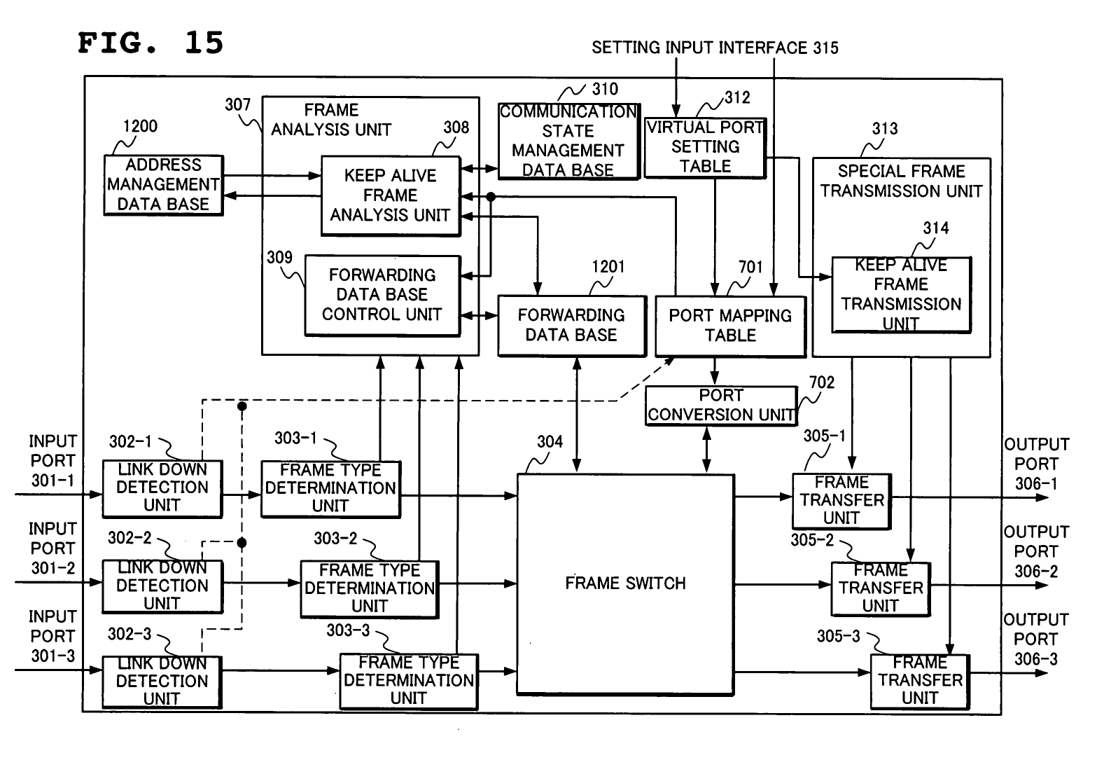

FIG. 15 is a block diagram showing a structure of the base node 100, the base node 101 and the base node 1000 shown in FIG. 14.

The structure of the base nodes in the fourth embodiment differs from the third embodiment in that the keep alive frame analysis unit 308 controls the address management data base 1200.

The keep alive frame analysis unit 308 manages a corresponding relationship between a partner node and a router connected to the partner node by the address management data base 1200. For this reason, unlike the third embodiment, a MAC address as a node identifier of a router is set for a MAC address of a partner node as partner node information in the address management data base 1200 of the base node.

(Description of Operation)

Since operation in the fourth embodiment is basically the same as the operation in the third embodiment, description will be made only with respect to a different point in the following.

First, a procedure of creating the address management data base 1200 by the base node 100 will be described.

The base node 100 creates the address management data base 1200 by transmitting and receiving a keep alive frame.

(Transmission of Keep Alive Frame)

First, description will be made of a procedure of transmitting a keep alive frame by the base node 100.

In the present embodiment, with a MAC address of the router 1400 stored in a pay load of a keep alive frame, the keep alive frame transmission unit 314 of the base node 100 transmits the keep alive frame and notifies, to a partner node, the MAC address of the router 1400 connected to the base node 100.

The MAC address of the router 1400 connected to the base node 100 may be manually set by the network manager or the MAC address of the router 1400 may be automatically set by the base node 100 with reference to an Ethernet (R) frame received from the router 1400.

(Reception of Keep Alive Frame)

Here, a procedure of receiving a keep alive frame by the base node to create the address management data base 1200 will be described.

The keep alive frame analysis unit 308 registers, in the address management data base 1200, a corresponding relationship between a MAC address of a transmission source node of a received keep alive frame and a MAC address of a router stored in a pay load of the keep alive frame.

When information related to a transmission source node of the keep alive frame already exists in the address management data base 1200, compare a MAC address of a router registered in the address management data base 1200 and the MAC address of the router stored in the pay load of the keep alive frame.

When the two MAC addresses are different, replace the MAC address of the router registered in the address management data base 1200 with the MAC address of the router stored in the keep alive frame.

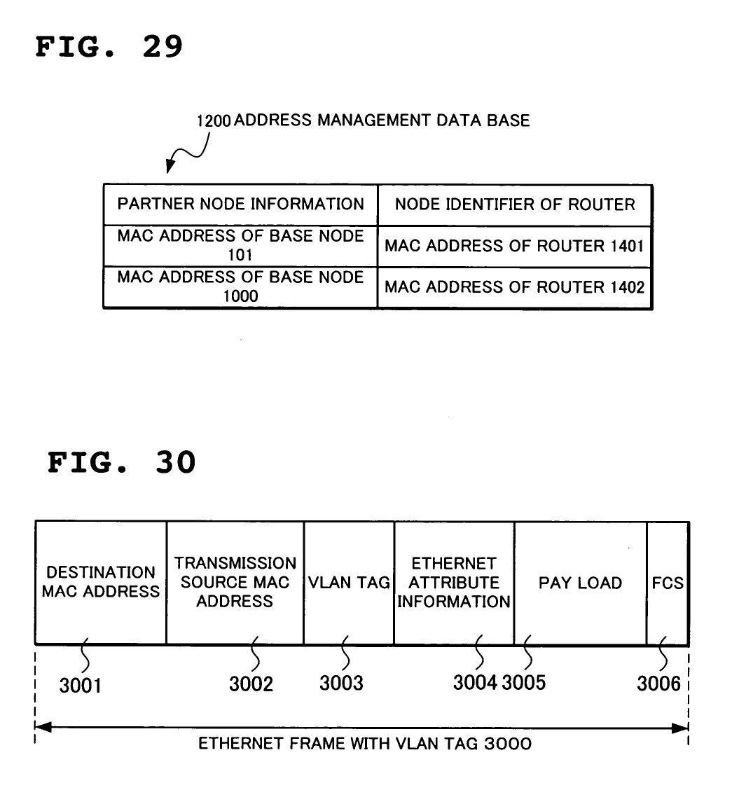

The address management data base 1200 shown in FIG. 29 is an example of an address management data base of the base 100 created by transmission/reception of a keep alive frame.

With reference to the address management data base 1200 shown in FIG. 29, it can be found that the router 1401 is connected to the base node 101 and the router 1402 is connected to the base node 1000.

As described in the foregoing, transmitting/receiving a keep alive frame whose pay load stores a MAC address of a router enables creation of the address management data base 1200.

Since according to the fourth embodiment, as in the third embodiment, it is unnecessary to manage a corresponding relationship between MAC addresses of all the hosts connected to a partner node and a MAC address of the partner node and it is only necessary to manage a corresponding relationship between a MAC address of a router connected to the partner node and the MAC address of the partner node, performance required of the base node and load on a network manager in setting can be drastically reduced. In particular, when the number of hosts connected to the base is large, the effect is large.

Moreover, without automatically creating the address management data base 1200 by transmission/reception of a keep alive frame as is done in the present embodiment, a corresponding relationship between a router connected to a partner node and the partner node may be manually registered in the address management data base 1200 by a network manager.

### Fifth Embodiment

Fifth embodiment of the present invention will be described in detail with reference to the drawings.

The fifth embodiment will be described with respect to a method of automatically creating an address management data base by transmission/reception of a learning frame by a base node.

(Structure of Communication System)

Since a structure of a communication system according to the fifth embodiment is the same as that of the third embodiment shown in FIG. 10, description thereof will be omitted.

(Structure of Base Node)

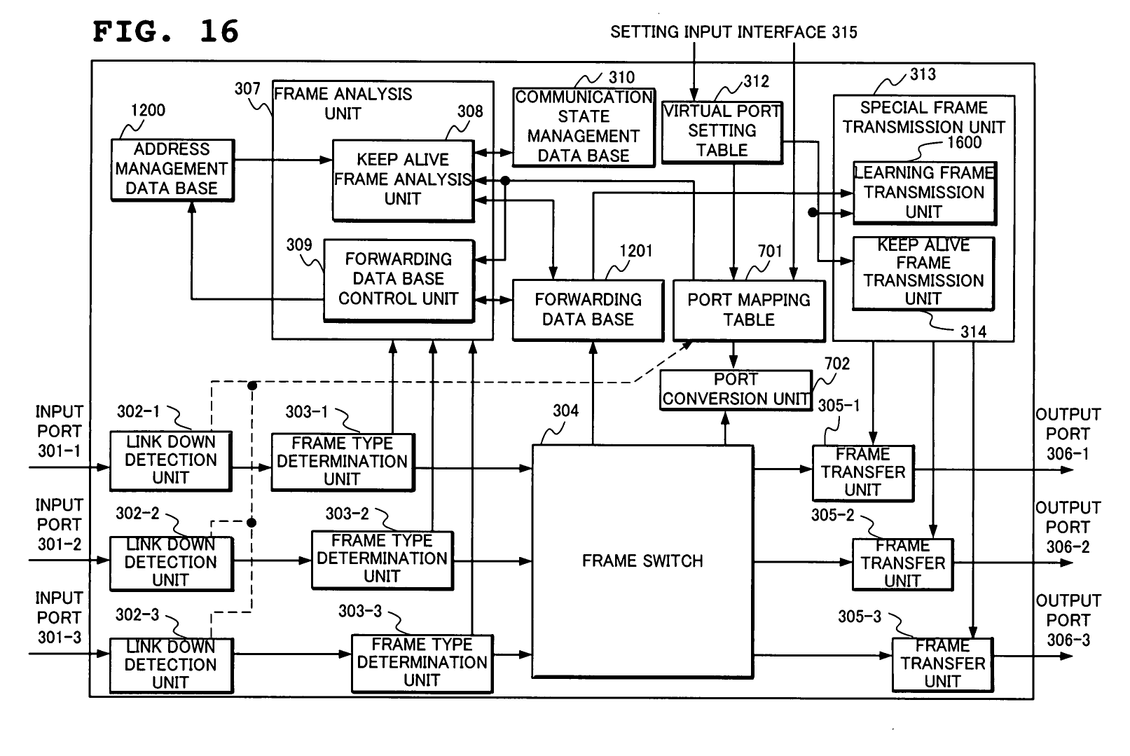

FIG. 16 is a block diagram showing the structure of the base node 100, the base node 101 and the base node 1000 illustrated in FIG. 10.

The fifth embodiment differs from the third embodiment in that the special frame transmission unit 313 includes a learning frame transmission unit 1600 which transmits a learning frame.

In addition, the fifth embodiment differs from the third embodiment in that the forwarding data base control unit 309 controls the address management data base 1200.

(Description of Operation)

Since operation in the fifth embodiment is basically the same as that in the third embodiment, description will be made only with respect to a different point in the following.

First, a procedure of creating the address management data base 1200 shown in FIG. 13 by the base node 100 will be described.

Upon transmission/reception of a learning frame by the base node 100, the forwarding data base control unit 309 automatically registers a corresponding relationship between a partner node and a host connected to the partner node in the address management data base 1200.

(Transmission of Learning Frame)

Description will be made of a procedure of transmitting a learning frame by the base node 100.

The learning frame transmission unit 1600 creates a learning frame related to all the hosts connected to a port not registered in the virtual port setting table 312 of the base node 100 in a manner as will be described later to transmit the same through a port set in the virtual port setting table 312.

The base node 100 transmits the learning frame to the partner node upon first reception of an Ethernet (R) frame transmitted from the host and new registration of information related to the host in the forwarding data base 1201.

Next, a learning frame will be detailed.

Description will be made of a case where a learning frame is realized by using a data frame having a frame format of Ethernet (R) shown in FIG. 25.

In addition, a learning frame can be realized by using a data frame having other frame format than the Ethernet (R) in the same manner as in the following description.

Stored in the destination MAC address 2501 of a learning frame is a MAC address by which the learning frame is transmitted to other base node (partner node) than the base node 100.

For example, with a MAC address of each partner node stored, a learning frame may be transmitted to each partner node, or similarly to the above-described keep alive frame, a MAC address may be used which enables a base node to recognize as a learning frame and obtains the same effect as that by broadcast in a relay node forming the communication media 106 and 107.

Stored in the transmission source node MAC address 2502 of a learning frame is a MAC address of the base node 100 which transmits the learning frame.

Stored in the Ethernet (R) attribute information 2503 of a learning frame is a data length or a type value of the learning frame.

Stored in the pay load 2504 of a learning frame are MAC addresses of all the hosts connected to the base node 100 which transmits the learning frame.

When the number of hosts is too large to store MAC addresses of all the hosts in the pay load, the learning frame may be divisionally transmitted a plurality of times.

Alternatively, such a method may be used of storing a MAC address of a host in the transmission source node MAC address 2502 of a learning frame and storing a MAC address of the base node 100 in the pay load 2504 of the learning frame to transmit as many learning frames as the number of hosts.

Stored in the FCS2505 of a learning frame is a value calculated by a predetermined calculation method.

(Reception of Learning Frame)

In the following, description will be made of a procedure of receiving a learning frame by the base node 100 to create the address management data base 1200.

The base node 100 receives a learning frame to register, in the address management data base 1200, a corresponding relationship between the transmission source MAC address 2501 of the learning frame and a MAC address stored in the pay load 2504 of the learning frame.

The learning frame received at the input ports 301-1˜3 of the base node 100 is transferred to the forwarding data base control unit 309 by the frame type determination units 303-1˜3.

The forwarding data base control unit 309 extracts the transmission MAC address of the learning frame (the MAC address of a partner node) and the MAC address stored in the pay load of the learning frame (the MAC address of a host connected to the partner node).

The forwarding data base control unit 309 registers a corresponding relationship between the extracted transmission source MAC address of the learning frame and host MAC address in the address management data base 1200.

When the corresponding relationship is already registered in the address management data base 1200, update the contents.

As described in the foregoing, transmission/reception of a learning frame leads to automatic creation of the address management data base 1200 shown in FIG. 13.

### Sixth Embodiment

Sixth embodiment of the present invention will be described in detail with reference to the drawings.

The sixth embodiment will be described with respect to a method of realizing a highly reliable communication system by using a port mapping table in which a plurality of virtual ports can be registered.

(Structure of Communication System)

Since a structure of a communication system according to the sixth embodiment is the same as that of the third embodiment shown in FIG. 10, description thereof will be omitted.

(Structure of Base Node)

Although a structure of a base node according to the sixth embodiment is basically the same as that of the third embodiment shown in FIG. 12, it differs from the third embodiment in including a port mapping table 1701 which is different from the port mapping table 701 and in that a plurality of virtual ports are registered as shown in FIG. 17.

In the port mapping table 1701, a virtual port can be registered for each partner node and for each virtual port, a port number and a real port are registered. Also registered in the port mapping table 1701 is one virtual port for broadcast transfer and multicast transfer.

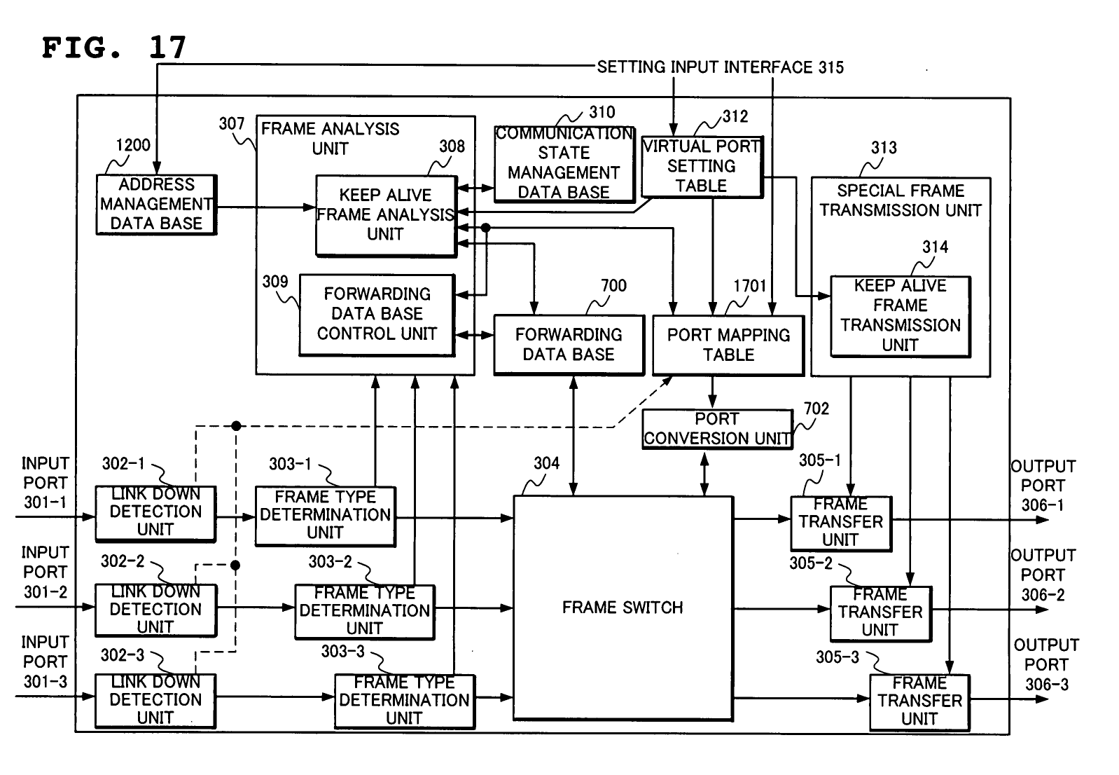

FIG. 18 shows one example of the port mapping table 1701 of the base node 100.

In the following, description will be made of a setting example of the port mapping table 1701 with reference to the port mapping table 1701 in FIG. 18.

In FIG. 18, a virtual port and a real port are registered for each of MAC addresses of the base node 101 and the base node 1000 and a broadcast MAC address as partner node information.

To the virtual port of the base node 101, the port number 11 is assigned and the port 1 and the port 2 registered in the virtual port setting table 312 of the base node 100 shown in FIG. 4 are registered as a real port.

In addition, to the virtual port of the base node 1000 shown in FIG. 10, a port number 12 is assigned and the port 1 and the port 2 are registered as a real port.

Furthermore, to the virtual port for broadcast transfer, a port number 21 is assigned and the port 1 and the port 2 are registered as a real port.

(Description of Operation)

(Transfer of Ethernet (R) Frame in Normal Operation)

Description will be made of a procedure of transferring an Ethernet (R) frame by the base node 100 in normal operation.

Since in the sixth embodiment, operation executed when the base node 100 in FIG. 10 transfers an Ethernet (R) frame directed to the host 105 which is transmitted from the host 104 is basically the same as that in the third embodiment, description will be made only with respect to a different point in the following.

(Creation of Forwarding Data Base)

In the following, a procedure of creating the forwarding data base 700 will be described.

In the present embodiment, when registering a virtual port in the output port information of the forwarding data base 700, a port number registered for each partner node (transmission source node) in the port mapping table 1701 is used.

Description will be made, for example, of a procedure of registering information related a transmission source of an Ethernet (R) frame in the forwarding data base 700 when the base node 100 receives the Ethernet (R) frame at the port 2 set in the virtual port setting table 312.

The forwarding data base control unit 309 registers a transmission source MAC address of the received Ethernet (R) frame in the destination node information of the forwarding data base 700.

With reference to the address management data base 1200 and the port mapping table 1701, the forwarding data base control unit 309 obtains a partner node correlated with the transmission source of the received Ethernet (R) frame to register a port number assigned to a virtual port of the obtained partner node in the output port information of the forwarding data base 700.

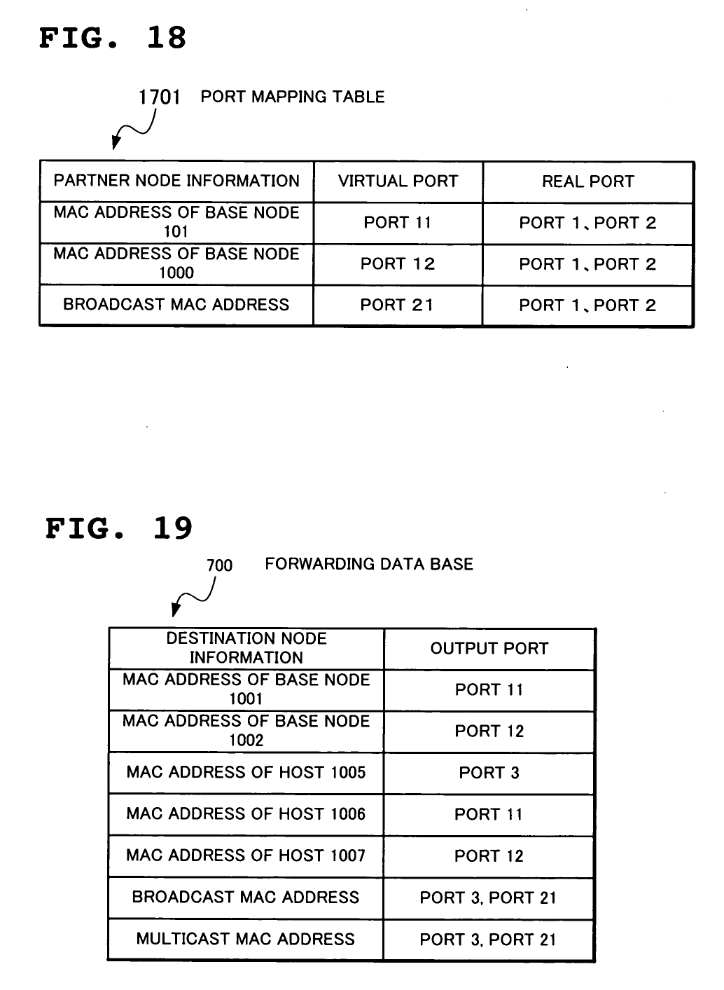

FIG. 19 shows one example of the forwarding data base 700 of the base node 100.

With reference to the forwarding data base 700 in FIG. 19, description will be made, for example, of a procedure of registering information related to the host 105 in the forwarding data base 700 when the base node 100 receives an Ethernet (R) frame directed to the host 104 which is transmitted from the host 1001 at the port 2.

Since the port 2 as an input port of the Ethernet (R) frame is set in the virtual port setting table 312 of the base node 100 shown in FIG. 4, registered in the output port information of the forwarding data base 700 is a port number assigned to the virtual port in the port mapping table 1701.

Since it can be found from the address management data base 1200 that the host 1001 is a host connected to the base node 1000, further with reference to the port mapping table 1701 shown in FIG. 18, the port 12 assigned to the virtual port of the base node 1000 is registered in the output port information.

(Transfer of Ethernet (R) Frame at Failure Detection)

In the following, description will be made of operation of transferring an Ethernet (R) frame by the base node 100 when detecting a failure.

(Transfer of Ethernet (R) Frame When Keep Alive Frame is Yet to Arrive)

First, description will be made of operation executed when the yet-to-arrive state of a keep alive frame is detected.

When the arrival state of a keep alive frame transmitted from a certain partner node goes to the yet-to-arrive state at a certain port, the keep alive frame analysis unit 308 deletes a port entering the yet-to-arrive state from real ports registered in the virtual port of the partner node in the port mapping table 1701.

Description will be made, with reference to the port mapping table 1701 of the base node 100 shown in FIG. 18, for example, of a case where the arrival state of a keep alive frame transmitted from the base node 101 goes to the yet-to-arrive state at the port 2 of the base node 100.

At this time, the keep alive frame analysis unit 308 of the base node 100 deletes the port 2 registered in the virtual port assigned to the base node 101 in the port mapping table 1701 shown in FIG. 18.

Accordingly, in the virtual port assigned to the base node 101, the port 1 is registered.

When the arrival state of a keep alive frame transmitted from a certain partner node to a certain port changes from the yet-to-arrive state to the received state, the keep alive frame analysis unit 308 adds the port entering the received state to the virtual port of the partner node.

When in the above-described example, the port 2 of the base node 100 is again allowed to receive the keep alive frame of the base node 101, again add the port 2 to the virtual port of the base node 101 registered in the port mapping table 1701 shown in FIG. 18.

On the other, when the arrival state of a keep alive frame transmitted from a certain partner node goes to the yet-to-arrive state at all ports set in the virtual port setting table 312, the keep alive frame analysis unit 308 registers all the ports set in the virtual port setting table 312 in the virtual port assigned to the partner node as is done in normal operation.

Alternatively, such a special port number that abandons an Ethernet (R) frame may be registered in the virtual port.

As to a virtual port for broadcast transfer, ports at which none of the yet-to-arrive state of a partner node is detected should be all registered.

At multilink failure detection when at all the ports set in the virtual port setting table 312, the yet-to-arrive state of a keep alive frame of an arbitrary partner node is detected, execute the same operation as in the third embodiment.

(Transfer of Ethernet (R) Frame at Link Down Detection)

Next, operation executed when link down is detected will be described.

When detecting link down of a port, the link down detection units 302-1˜3 delete the linked down port from all the virtual ports in the port mapping table 1701.

As described above, by detecting non-arrival and link down of a keep alive frame to delete a port at which a failure is detected from the virtual port, the base node is allowed to continue communication using only a port in which no failure is detected.

Thus setting a virtual port for each partner node in the port mapping table 1701 and using a port number assigned to each virtual port enables a communication system having high reliability to be realized.

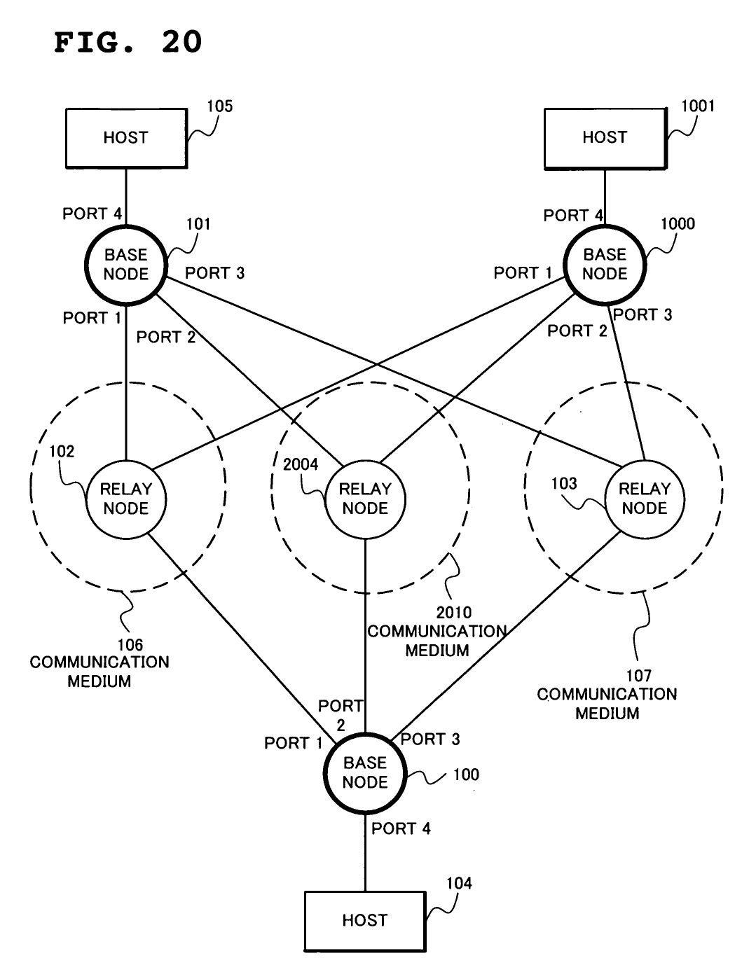

Also to such a communication system in which the base nodes 100, 101 and 1000 are connected to three or more communication media, 106 and 107 and a communication medium 2010 having a relay node 2004 as shown in FIG. 20, the above-described manner can be applied only by adding a real port to the virtual port registered in the port mapping table 1701.

### Seventh Embodiment

Seventh embodiment of the present invention will be described in detail with reference to the drawings.

The seventh embodiment will be described with respect to a method of realizing high reliability in a communication system in which a frame format of a data frame transferred by a relay node varies with a communication medium.

(Structure of Communication System)

Since a structure of the communication system according to the seventh embodiment is basically the same as that in the third embodiment shown in FIG. 10, description will be made only with respect to a different point in the following.

In the third embodiment, the relay nodes 102 and 103 forming the communication media are all Ethernet (R) switches which transfer an Ethernet (R) frame.

The seventh embodiment, in which the relay node 102 forming the communication medium 106 is an Ethernet (R) switch, however, differs from the third embodiment in that the relay node 103 forming the communication medium 107 is a node (IP router) for transferring an IP packet.

Moreover, while in the present embodiment, the relay nodes forming the communication medium 106 and the communication medium 107 are an IP router and an Ethernet (R) switch, respectively, they may be a node which transfers an IP packet or a data frame having an arbitrary frame format other than an Ethernet (R) frame.

It is possible, for example, to use, as a relay node forming a communication medium, an ATM switch which transfers an ATM cell or a frame relay switch which transfers a frame relay frame.

(Structure of Base Node)

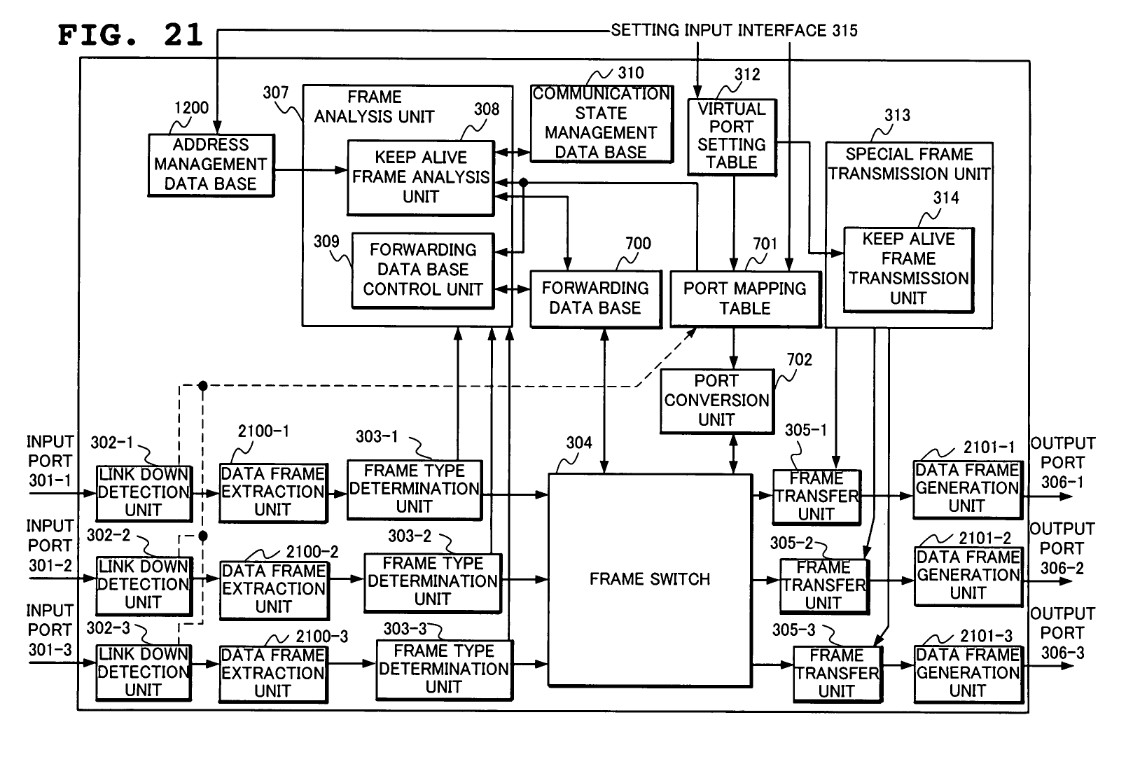

FIG. 21 is a block diagram showing a structure of the base node 100, the base node 101 and the base node 1000 shown in FIG. 10 according the seventh embodiment.

The seventh embodiment differs from the third embodiment in that the base node 100 (also the case with the base node 101 and the base node 1000) newly includes data frame generation units 2100-1˜3 (*2101-1˜3 ?) and data frame extraction units 2101-1˜3 (*2100-1˜3 ?).

The data frame generation units 2101-1˜3 generate an IP packet whose datagram stores an Ethernet (R) frame.

The data frame extraction units 2100-1˜3 extract an Ethernet (R) frame stored in the datagram of a received IP packet.

Assume that the data frame generation units 2101-1˜3 and the data frame extraction units 2100-1˜3 are allowed to know a frame format of a data frame transferred by a relay node forming the communication medium connected to the input ports 301-1˜3 and the output ports 306-1˜3 by the setting by a network manager.

In addition, as shown in FIG. 22 as the block diagram illustrating a structure of the base node 100, the base node 100 may contain an IP router 2200.

When the relay node forming the communication medium is an ATM switch or a frame relay switch, the IP router 2200 in FIG. 22 should be replaced by an ATM switch or a frame relay switch.

(Description of Operation)

In the following, operation of transferring an Ethernet (R) frame directed to the host 105 from the host 104 by the base node 100 in FIG. 10 will be described.

(Transmission of Data Frame)

An Ethernet (R) frame transmitted directed to the host 105 from the host 104 is received at the port 3 of the base node 100.

The following operation will be described with reference to FIG. 21.

The Ethernet (R) frame received at the input port 301-3 (port 3) of the base node 100 is transferred to the frame switch 304 by the frame type determination unit 303-3.

The frame switch 304 selects either one of the port 1 and the port 2 registered in the virtual port by such a specific algorithm as described in the first embodiment to transfer the Ethernet (R) frame to the frame transfer unit 305-1˜3 corresponding to the port.

In the following, description will be made of operation executed when the port 2 connected to the communication medium 107 formed of an IP router is selected as an output port.

(Capsulation)

The frame transfer unit 305-2 transfers, to the data frame generation unit 2101-2, an Ethernet (R) frame transferred from the frame switch 304.

When the communication medium connected to the output port 306-2 is formed of an IP router, the data frame generation unit 2101-2 generates an IP packet which will be described later from the Ethernet (R) frame transferred from the frame transfer unit 305-2 to transmit the same through the output port 306-2.

When the communication medium connected to the output port 306-2 is formed of an Ethernet (R) switch, the data frame generation unit 2101-2 transmits the Ethernet (R) frame transferred from the frame transfer unit 305-2 through the output port 306-2 without executing any processing.

Here, with reference to a frame format of the IP packet 2600 shown in FIG. 26, an IP packet generated by the data frame generation unit 2101-2 will be described.

In a destination IP address of an IP header 2601, an IP address assigned to the base node 101 to which the host 105 is connected is stored.

Alternatively, an IP address is stored which is assigned to a port (port 2) connected to the communication medium 107 among the ports of the base node 101.

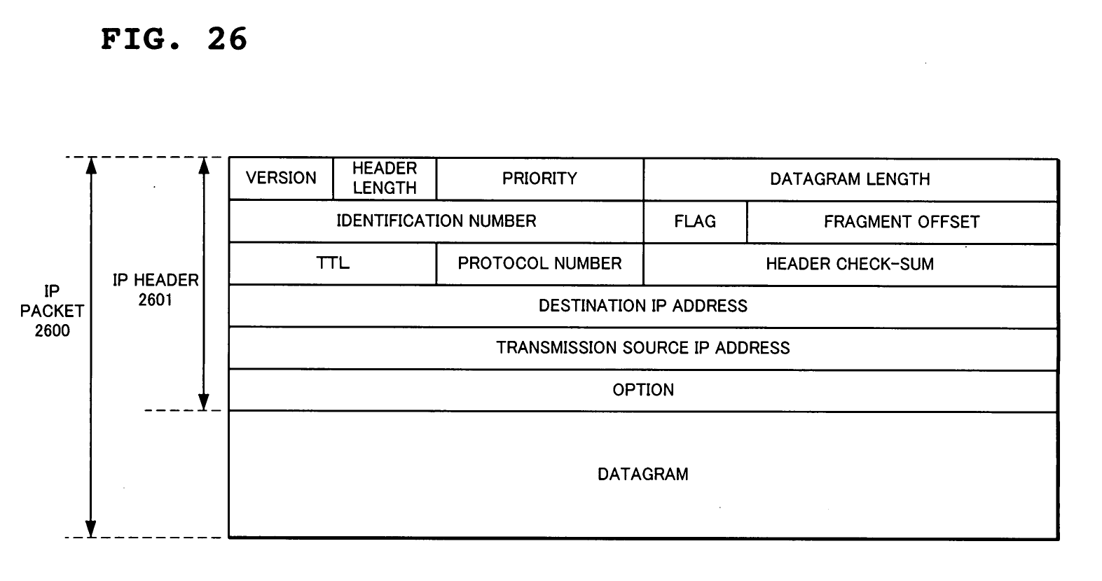

An IP address stored in the destination IP address may be registered as IP header information for each destination MAC address to enable the data frame generation unit 2101-2 to refer to as shown in a forwarding data base 700A in FIG. 27.

In addition, the base node 100 may separately prepare a data base in which IP header information for generating an IP packet is registered with respect to a destination MAC address of an Ethernet (R) frame and a real port through which the Ethernet (R) frame is sent out.

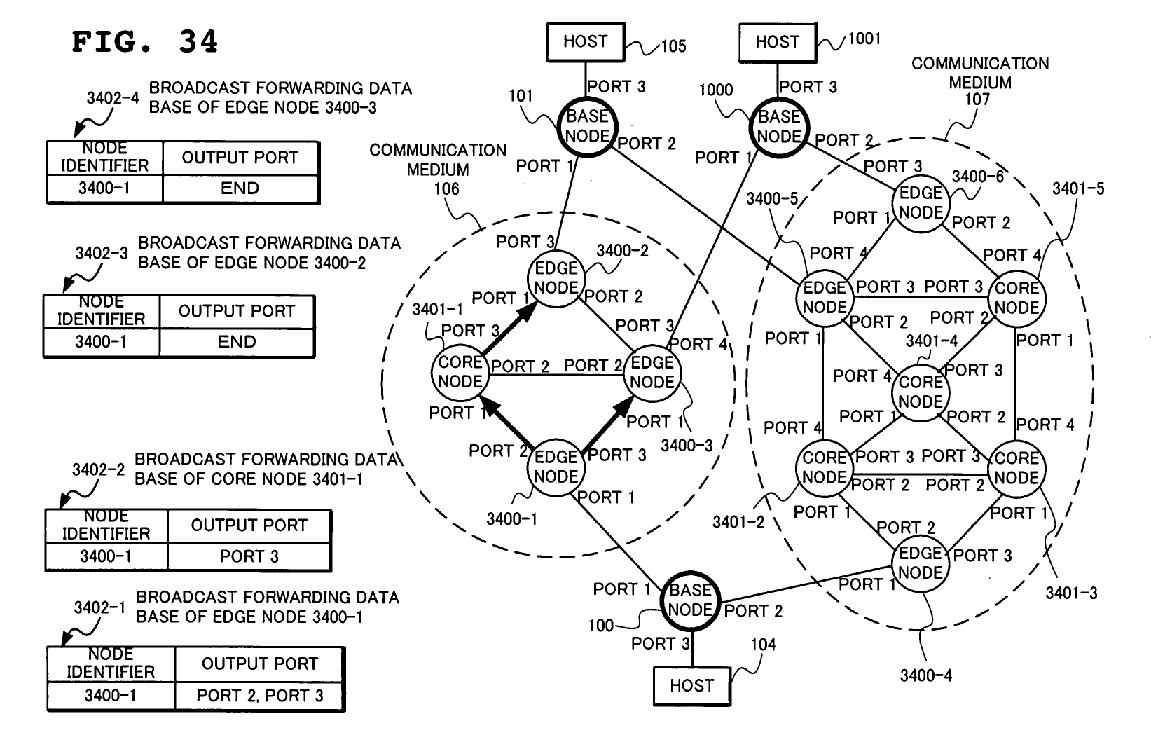

For example, such a data base as shown in FIG. 33 may be prepared in which for a MAC address of the host 105 and the output port 306-2, registered is an IP address (IP header information) assigned to a port (port 2) to which the communication medium 107 of the base node 101 is connected.

Stored in the transmission source IP address is an IP address assigned to the port (port 2) to which the communication medium 107 of the base 100 is connected or an IP address assigned to the base node 100.

In the datagram of the IP packet, the Ethernet (R) frame transferred from the frame transfer unit 305-2 is stored.

In other fields of the IP header, an appropriate value is stored according to such conditions as network environments of the communication medium 107 and the contents of an Ethernet (R) frame to be transmitted.

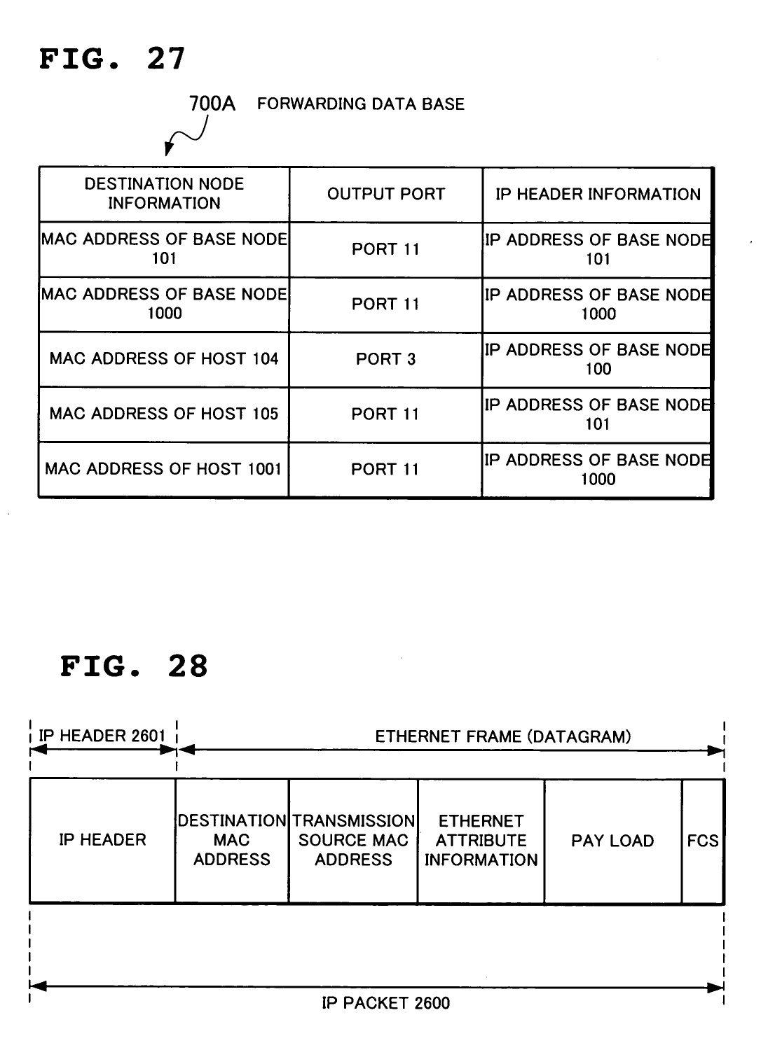

As described in the foregoing, the data frame generation unit 2101-2 generates an IP packet 2600 with the IP header 2601 added to the Ethernet (R) frame as shown in FIG. 28.

Although the Ethernet (R) frame stored in the datagram of the IP packet 2600 shown in FIG. 28 has no tag such as a VLAN tag added, it may be an Ethernet (R) frame with a tag.

Also when the relay node 103 forming the communication medium 107 is a node for transferring a data frame having other frame format than that of an IP packet, the data frame may be generated by the same manner as in the above-described case of the IP router.

As described above, such processing of storing, in a pay load of a data frame having an arbitrary frame format, another data frame is generally called capsulation.

(Reception of Data Frame)

Next, description will be made of operation executed when the base node 100 receives an IP packet from the communication medium 107 formed of an IP router.

An IP packet received from the input port 301-2 is transferred to the data frame extraction unit 2100-2.

When a destination IP address of the IP packet coincides with an IP address assigned to the input port 301-2 or an IP address assigned to the base node 100, the data frame extraction unit 2100-2 removes an IP header from the IP packet to extract an Ethernet (R) frame stored in the datagram and transfer the same to the frame type determination unit 303-2.

In a case where the communication medium connected to the input port 301-2 is formed of an Ethernet (R) switch and the input port 301-2 is not an IP packet but receives an Ethernet (R) frame, the data frame extraction unit 2100-2 transfers the received Ethernet (R) frame to the frame type determination unit 303-2 without any processing.

Since operation to be executed hereafter is the same as in the third embodiment, description thereof will be omitted.

Thus transmitting a data frame (IP packet) with an Ethernet (R) frame stored in a pay load (datagram) and extracting the Ethernet (R) frame stored in the pay load of the received data frame enables a highly reliable communication system to be provided similarly to the case where relay nodes forming communication media are all Ethernet (R) switches even when a frame format of a data frame which can be transferred on the communication medium varies.

### Eighth Embodiment

Eighth embodiment of the present invention will be described in detail with reference to the drawings.

The present embodiment provides a function of automatically creating the address management data base 1200 shown in FIG. 13 which is manually set by a network manager in the third embodiment.

(Structure of Communication System)

Since a structure of a communication system according to the eighth embodiment is the same as that of the third embodiment shown in FIG. 10, description thereof will be omitted.

(Structure of Base Node)

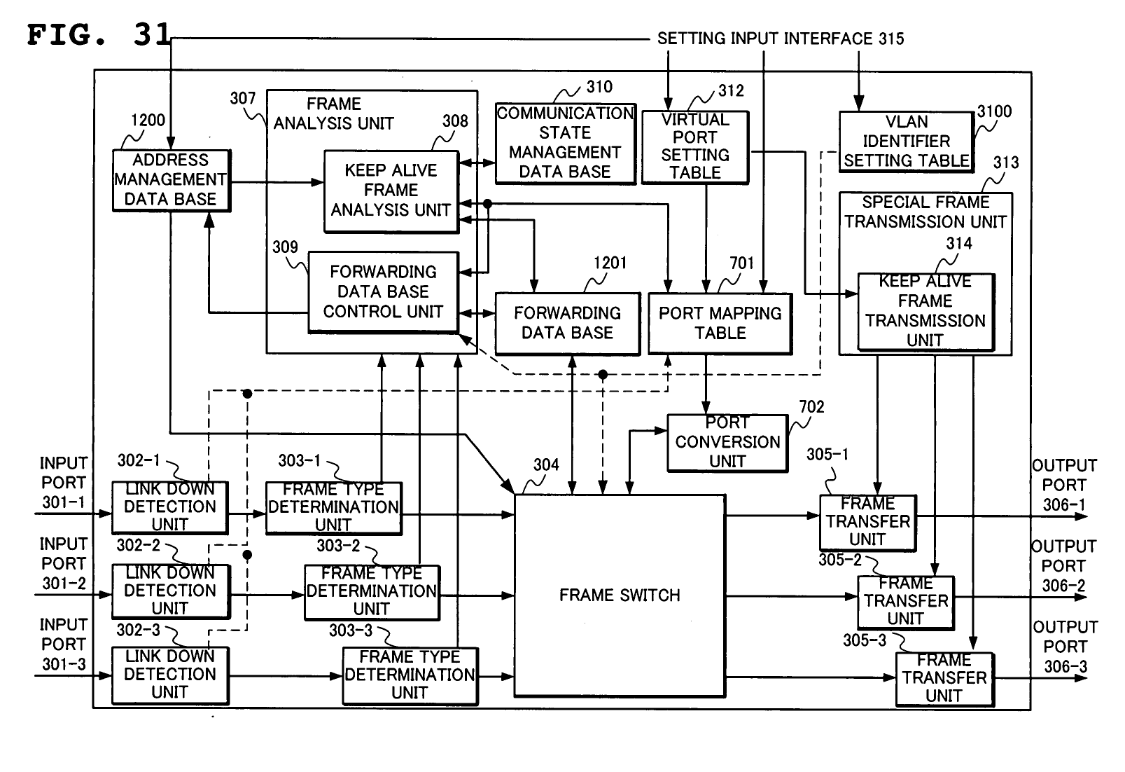

FIG. 31 is a block diagram showing a structure of the base node 100, the base node 101 and the base node 1000 in FIG. 10 according to the present embodiment.

The eighth embodiment differs from the third embodiment in that the base node 100 newly includes a VLAN identifier setting table 3100.

The VLAN identifier setting table 3100 is a table for setting a VLAN identifier for each arbitrary combination between a MAC address of each base node and a broadcast MAC address.

In the present embodiment, the VLAN identifier setting table 3100 is manually set by a network manager by using the setting input interface 315.

Alternatively, the VLAN identifier setting table 3100 may be automatically created by communication between the respective nodes by using a keep alive frame or the like.

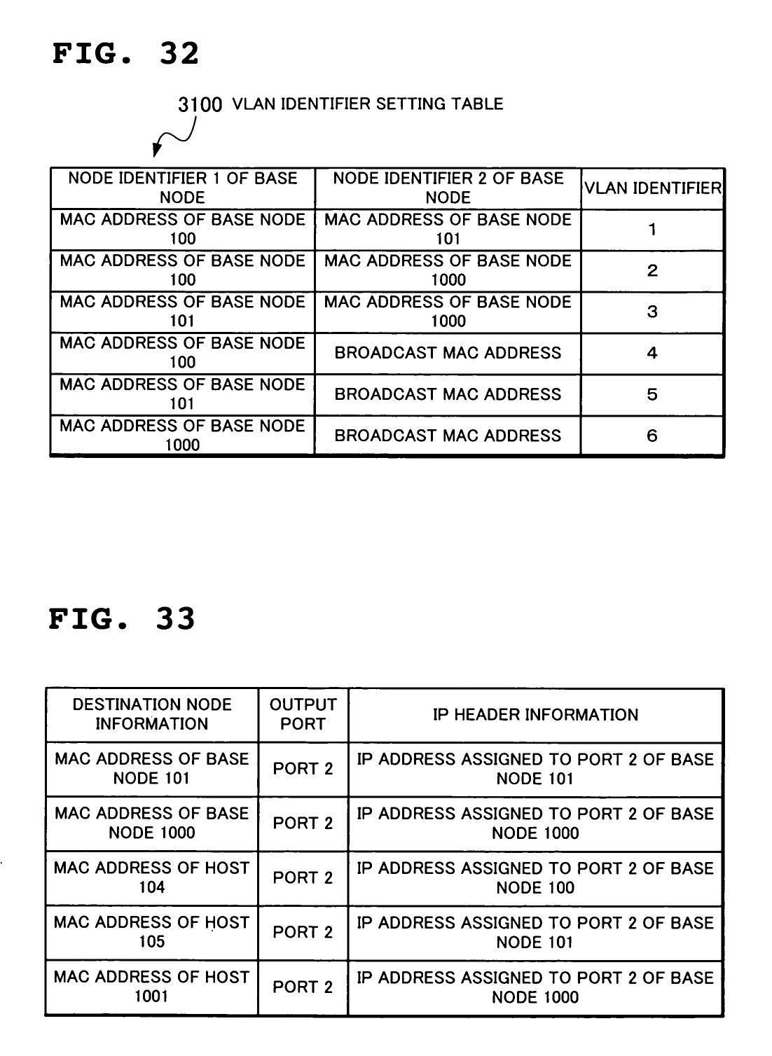

FIG. 32 shows one example of the VLAN identifier setting table 3100 of the base node 100, the base node 101 and the base node 1000.

In the VLAN identifier setting table 3100 shown in FIG. 32, an arbitrary combination selected from among a MAC address of the base node 100, a MAC address of the base node 101, a MAC address of the base 1000 and a broadcast MAC address is set for a node identifier 1 and a node identifier 2, and to the combination, an integer value from “1” to “6” is allotted as a VLAN identifier so as not to overlap with each other.

In FIG. 32, for example, to a VLAN identifier allotted to a combination between the MAC address of the base node 100 and the MAC address of the base node 101, the integer value “1” is set.

In the following, description will be made assuming that the VLAN identifier setting table 3100 of the base node 100, the base node 101 and the base node 1000 is set as shown in FIG. 32.

(Description of Operation)

First, operation of transferring an Ethernet (R) frame directed to the host 105 from the host 104 will be described.

(Outlines of Transfer of Ethernet (R) Frame)

The present embodiment differs from the third embodiment in that the base node 100 transmits an Ethernet (R) frame with a VLAN tag which will be described later added at a predetermined position of the Ethernet (R) frame.

Stored in the VLAN tag is a VLAN identifier which enables a base node to which a transmission source belongs and a base node to which a destination belongs to be identified.

More specifically, according to the VLAN identifier setting table 3100, a VLAN identifier is stored which is assigned to the combination between the MAC address of the base node 100 to which the transmission source (host 104) belongs and the MAC address of the base node 101 to which the destination (host 105) belongs.

The Ethernet (R) frame with the VLAN tag added is transferred to the port 1 or the port 2 of the base node 101 through the communication medium 106 or the communication medium 107.

With reference to the VLAN identifier stored in the VLAN tag of the received Ethernet (R) frame and the VLAN identifier setting table 3100, the base node 101 extracts the MAC address of the base node to which the transmission source host belongs and registers a corresponding relationship between the MAC address of the transmission source host and the extracted MAC address of the base node in the address management data base 1200 in FIG. 13.

The base node 101 also removes the VLAN tag added by the base node 100 from the received Ethernet. (R) frame to transfer the obtained Ethernet (R) frame from the port 3 to the host 105.

Thus transmitting and receiving an Ethernet (R) frame with a VLAN tag added in which a VLAN identifier allotted to a combination between a base node to which a transmission source host belongs and a base node to which a destination host belongs is stored, the address management data base 1200 can be automatically created.

(Transfer of Ethernet (R) Frame, Creation of Address Management Data Base)

In the following, detailed description will be made of a procedure of creating the address management data base 1200 in FIG. 13 by transmission and reception of an Ethernet (R) frame with a VLAN tag added by the base node 100.

(Transmission of Ethernet (R) Frame)

First, description will be made of operation executed when the base node 100 transmits an Ethernet (R) frame from a port set in the virtual port setting table 312.

Since in the present embodiment, a procedure of transmitting an Ethernet (R) frame from a port set in the virtual port setting table 312 is basically the same as that in the third embodiment, only a different point will be described in the following.

When an output port of an Ethernet (R) frame is a port set in the virtual port setting table 312, the frame switch 304 of the base node 100 adds a VLAN tag to a predetermined position of the Ethernet (R) frame.

FIG. 30 shows a frame format of an Ethernet (R) frame 3000 with a VLAN tag to which a VLAN tag is added.

Stored in a VLAN tag 3003 is a VLAN identifier allotted to a combination between a MAC address of a base node to which a transmission source host of the Ethernet (R) frame belongs and a MAC address of a base node to which a destination host belongs according to the VLAN identifier setting table 3100.

Here, a base node to which a transmission source host belongs is the own node.

In addition, a base node to which a destination host belongs is a base node correlated with the destination host by the address management data base 1200.

When information about a base node to which a destination host belongs fails to exist in the address management data base 1200, a VLAN identifier allotted to a combination between a MAC address of a base node to which a transmission source host belongs and a broadcast MAC address is stored in the VLAN tag 3003.

Description will be made, with reference to the VLAN identifier setting table 3100 in FIG. 32, for example, of a VLAN identifier stored in the VLAN tag 3003 when the base node 100 transmits an Ethernet (R) frame sent directed to the host 105 from the host 104 through the port 1 or the port 2.

When information about the base node 101 to which the host 105 as a destination belongs exists in the address management data base 1200, the integer value “1” as a VLAN identifier allotted to a combination between a MAC address of a base node (base node 100) to which the host 104 as a transmission source belongs and a MAC address of a base node (base node 101) to which the host 105 as a destination belongs is stored in the VLAN tag 3003.

When the information about the base node 101 to which the host 105 belongs fails to exist in the address management data base 1200, the integer value “4” as a VLAN identifier allotted to a combination between a MAC address of the base node 100 to which the host 104 as a transmission source belongs and a broadcast MAC address is stored in the VLAN tag.

(Reception of Ethernet (R) Frame)

Next, description will be made of a procedure of receiving an Ethernet (R) frame with a VLAN tag at a port set in the virtual port setting table 312 to automatically create the address management data base 1200 by the base node 100.

The frame type determination units 303-1˜3 transfer a received Ethernet (R) frame to the forwarding data base control unit 309.

The frame type determination units 303-1˜3 also remove the VLAN tag from the received Ethernet (R) frame to transfer the obtained frame to the frame switch 304.

The forwarding data base control unit 309 refers to the VLAN identifier setting table 3100 to obtain, among MAC addresses of two base nodes corresponding to a VLAN identifier stored in the VLAN tag of the Ethernet (R) frame, a MAC address (MAC address of a base node to which a transmission source host belongs) different from a MAC address of the own node (base node 100).

The forwarding data base control unit 309 registers a corresponding relationship between a transmission source MAC address (MAC address of a transmission source host) of the Ethernet (R) frame and the obtained MAC address of the base node in the address management data base 1200.

When there already exists, in the address management data base 1200, the corresponding relationship between the transmission source host MAC address and the MAC address of the base node to which the transmission source host belongs, update the contents.

Since a procedure of transferring the received Ethernet (R) frame by the frame switch 304 is the same as that in the third embodiment, description thereof will be omitted.

Thus transmitting and receiving an Ethernet (R) frame with a VLAN tag added by the base node enables automatic creation of the address management data base 1200.

(Failure Detection by Keep Alive Frame, Transfer of Ethernet (R) Frame at Failure Detection)

Since a procedure of detecting a failure by transmitting and receiving a keep alive frame by the base node 100 and a procedure of transferring an Ethernet (R) frame at failure detection in the eighth embodiment are the same, as described with respect to the procedure of transferring an Ethernet (R) frame in normal operation, as those of the third embodiment except that the base node 100 transmits an Ethernet (R) frame with a VLAN tag added, description thereof will be omitted.

(Transfer of Broadcast Frame, Multicast Frame and Unknown Unicast Frame at Multilink Failure Detection)

In the following, description will be made of operation executed by the base node 100 when transferring a broadcast frame, or a multicast frame or a unicast frame whose destination information is not registered in the forwarding data base 1201 (unknown unicast frame) at multilink failure detection.

While the following is the description of operation of transferring a broadcast frame, this is also the case with operation for a multicast frame and an unknown unicast frame.

First, a procedure of transmitting a broadcast frame at multilink failure detection will be described.

When transmitting a broadcast frame at multilink failure detection, the base node 100, similarly to the third embodiment, transmits a broadcast frame from all the real ports set in the virtual port setting table 312.

As has been described with respect to the procedure of transferring an Ethernet (R) frame in normal operation, the base node 100 transmits a broadcast frame with a VLAN tag added in which a VLAN identifier allotted to a combination between a MAC address of the base node 100 and a broadcast MAC address is stored based on the VLAN identifier setting table 3100.

In the example shown in FIG. 32, the integer value “4” as a VLAN identifier allotted to a combination between the MAC address of the base node 100 and the broadcast MAC address in the VLAN identifier setting table 3100 is added as a VLAN tag, for example.

Thus transmitting a broadcast frame from all the ports set in the virtual port setting table 312 enables transfer of an Ethernet (R) frame to all the partner nodes even when a multilink failure is detected.

Next, a procedure of receiving a broadcast frame will be described.

As has been described also in the third embodiment, a base node which detects a multilink failure might receive an Ethernet (R) frame multicast-transferred by a partner node a plurality of times at a port registered in the virtual port setting table 312.

Therefore, when a multilink failure is detected, allowing reception of a broadcast frame only at one port among the ports set in the virtual port setting table 312 and abandoning a broadcast frame at other ports prevents a plurality of times of reception of the same Ethernet (R) frame.

At this time, the base node 100 needs to distinguish between an Ethernet (R) frame broadcast-transferred from the partner node and a unicast-transferred Ethernet (R) frame to execute the above-described processing only with respect to the broadcast-transferred Ethernet (R) frame.

Since referring to the destination MAC address of a received Ethernet (R) frame enables the base node 100 to distinguish among a unicast frame, a broadcast frame and a multicast frame, the node can execute the above-described processing with respect to a broadcast frame and a multicast frame.

There is a problem, however, that when the received Ethernet (R) frame is a unicast frame, the base node 100 is not allowed to identify the unicast frame as an unknown unicast frame broadcast-transferred by the partner node or a unicast-transferred Ethernet (R) frame.

In order to solve the problem, the base node 100 distinguishes a kind of Ethernet (R) frame with reference to the VLAN identifier stored in the VLAN tag of the received Ethernet (R) frame in the present embodiment.

When the VLAN identifier stored in the VLAN tag of the received Ethernet (R) frame is a VLAN identifier allotted to a combination between a MAC address of an arbitrary base node and a broadcast MAC address, the base node 100 determines whether the received Ethernet (R) frame is a broadcast frame, a multicast frame or an unknown unicast frame to execute the above-described processing with respect to the received Ethernet (R) frame.

A port to be allowed of reception should be determined by a similar manner to that described in the third embodiment.

Thus referring to a VLAN tag prevents a plurality of times of reception of such an Ethernet (R) frame as an unknown unicast frame that disables just reference to a destination MAC address to determine whether the frame is broadcast-transferred by a partner node or not.

### Ninth Embodiment

Ninth embodiment of the present invention will be described in detail with reference to the drawings.

The ninth embodiment will be described with respect to a mechanism of transfer of a keep alive frame transmitted from a base node to a communication medium.

(Structure of Communication System)

FIG. 34 shows a structure of a communication system according to the ninth embodiment.

In the communication system according to the ninth embodiment, relay nodes (edge node 3400-1˜6 and core nodes 3401-1˜5) forming the communication medium 106 and the communication medium 107 broadcast-transfer a broadcast frame or an unknown unicast frame based on a node identifier stored in an expansion tag which will be described later and output port information registered in the broadcast forwarding data base which will be described later.

The communication medium 106 is formed of the edge nodes 3400-1˜3 and the core node 3401-1 as a relay node and the communication medium 107 is formed of the edge nodes 3400-4˜6 and the core nodes 3401-2˜5 as a relay node.

The edge nodes 3400-1˜6, which are the relay nodes connected to the base nodes 100 and 101 and the base node 1000 among the relay nodes forming the communication media 106 and 107, add an expansion tag to a broadcast frame received from the base nodes 100 and 101 and the base node 1000 to transfer the broadcast frame with an expansion tag with reference to a node identifier stored in the expansion tag and the broadcast forwarding data base.

The core nodes 3401-1˜5, which are the relay nodes other than the edge nodes 3400-1˜6, transfer a broadcast frame with an expansion tag with reference to a node identifier stored in the expansion tag and the broadcast forwarding data base.

While the communication system according to the ninth embodiment in FIG. 34 is a communication system having three base nodes, it may be a communication system having two base nodes as in the first and second embodiments or a communication system having three or more base nodes.

(Structure of Base Node)

Since the structure and operation of the base node in the ninth embodiment are the same as those of the third embodiment, description thereof will be omitted.

As is already mentioned in the first embodiment, a keep alive frame is recognized as an unknown unicast frame by the relay nodes forming the communication media 106 and 107, broadcast-transferred through the communication media 106 and 107 and transferred to all the base nodes.

In the following, description will be made of a procedure of transferring a broadcast frame and an unknown unicast frame (keep alive frame) by using a broadcast frame with an expansion tag by the relay nodes forming the communication media 106 and 107.

As an example of broadcast transfer, description will be in the following made of operation executed when the edge nodes 3400-1˜3 and the core node 3401-1 forming the communication medium 106 broadcast-transfer a broadcast frame received from the base node 100.

Such an unknown unicast frame as a keep alive frame can be also broadcast-transferred similarly to a broadcast frame by using the following method.

Upon receiving a broadcast frame from the base node 100, the edge node 3400-1 adds an extension tag which stores a node identifier of the edge node 3400-1 to the broadcast frame.

For example, an Ethernet (R) frame with a VLAN tag can be used as an example of an Ethernet (R) frame with an expansion tag added. FIG. 30 shows a frame format of a broadcast frame with an expansion tag in a case where an Ethernet (R) frame with a VLAN tag is used as an Ethernet (R) frame with an expansion tag.

The edge node 3400-1 identifies a node identifier (node identifier of the edge node 3400-1) stored in an expansion tag of a broadcast frame with an expansion tag to obtain output port information registered in the node identifier of the edge node 3400-1 from a broadcast forwarding data base 3402-1 provided in the edge node 3400-1 in FIG. 34.

Here, detailed description will be made of broadcast forwarding data bases 3402-1˜4 shown in FIG. 34.

The broadcast forwarding data bases 3402-1˜4 are data bases for registering output port information for node identifiers of the edge nodes 3400-1˜3.

For the sake of simplification, only output port information for a node identifier of the edge node 3400-1 is described in the broadcast forwarding data bases 3402-1˜4.

The output port information registered in the broadcast forwarding data bases 3402-1˜4 is determined in the following manner.

A broadcast transfer path from the edge node 3400-1 is determined by using a spanning tree protocol (STP).

More specifically, a path downstream along an active link of a spanning tree with the edge node 3400-1 as a route node will be a broadcast path from the edge node 3400-1.

Bold arrows drawn between the relay nodes forming the communication medium 106 in FIG. 34 show an example of a broadcast transfer path from the edge node 3400-1.

Although not shown in the figure, broadcast transfer paths from all the edge nodes (edge nodes 3400-2˜6) belonging to the communication medium 106 and the communication medium 107 in FIG. 34 are set similarly to the above-described broadcast transfer paths from the edge node 3400-1.

Since a broadcast transfer path from the edge node 3400-1 is determined by a spanning tree with the edge node 3400-1 as a route node as described in the foregoing, output port information for the edge node 3400-1 in the broadcast forwarding data bases 3402-1˜3 is determined by using information of the spanning tree at other port than that in a blocked state.

Output port information for the node identifiers of the edge node 3400-2 and the edge node 3400-3 in the broadcast forwarding data bases 3402-1˜4 is also determined in a manner similar to that of the edge node 3400-1.

With reference to the broadcast forwarding data base 3402-1, the edge node 3400-1 obtains information that output ports of a broadcast frame whose expansion tag stores a node identifier of the edge node 3400-1 are the port 2 and the port 3 to send out the broadcast frame with an expansion tag to the port 2 and the port 3.

Upon receiving the broadcast frame with an expansion tag from the edge node 3400-1, the core node 3401-1 obtains the node identifier (the node identifier of the edge node 3400-1) stored in the expansion tag, refers to the output port information for the node identifier in the broadcast forwarding data base 3402-2 to obtain information that an output port of the broadcast frame with an expansion tag is the port 3 and sends out the broadcast frame with an expansion tag to the port 3.

Upon receiving the broadcast frame with an expansion tag from the core node 3401-1, the edge node 3400-2 obtains an identifier “END” as output port information of the broadcast frame with an expansion tag with reference to the node identifier stored in the expansion tag and the broadcast forwarding data base 3400-3.

When the output port information is the identifier “END”, the edge node 3400-2 deletes the expansion tag added to the broadcast frame to convert the frame into a normal broadcast frame.

The edge node 3400-2 broadcast-transfers the broadcast frame with the expansion tag deleted to the input port (port 1) and all the ports (port 3) other than the ports (port 1 and port 2) to which other relay nodes are connected.

Similarly to the edge node 3400-2, the edge node 3400-3 refers to the node identifier stored in the expansion tag and the broadcast forwarding data base 3403-4 to obtain the output information “END” and broadcast-transfers the broadcast frame with the expansion tag deleted to the input port (port 1) and all the ports (port 4) other than the ports (ports 1 to 3) to which other relay nodes are connected.

Thus, the relay nodes forming the communication media 106 and 107 are allowed to broadcast-transfer a broadcast frame and such an unknown unicast frame as a keep alive frame by using a broadcast frame with an expansion tag.

While the communication system shown in FIG. 34 is an example of a communication system in which all the communication media (communication medium 106 and the communication medium 107) existing between base nodes execute broadcast-transfer by using a broadcast frame with an expansion tag, the present invention is applicable, similarly to the above-described case, also to a communication system in which only a part of communication media existing between base nodes executes broadcast-transfer by using a broadcast frame with an expansion tag.

When broadcast-transferring a broadcast frame by the above-described method, the following advantages over the conventional broadcast transfer can be obtained.

Since a broadcast frame transmitted from the edge nodes 3400-1˜6 is broadcast-transferred downstream along an active link of a spanning tree with each edge node as a route node, a broadcast frame can be transferred by using a shortest path.

In addition, since with a conventional need of MAC address search in the forwarding data base eliminated, the core nodes 3401-1˜5 are allowed to determine an output port based on a node identifier stored in an expansion tag, a broadcast frame can be transferred at a high speed.

In the communication system according the present invention, the respective components of the base node can be realized not only as hardware but also as software by loading and executing a communication control program (application) which realizes the functions of the base node on a program-controlled central processing unit (CPU), so that a system which executes the processing set forth in the following can be provided. The communication control program is stored in a magnetic disk, a semiconductor memory or other recording medium and loaded from the recording medium into the central processing unit to control operation of the central processing unit, thereby realizing the functions as the base node.

Although the present invention has been described with respect to the preferred embodiments in the foregoing, the present invention is not necessarily limited to the above-described embodiments and can be implemented in variations within the scope of its technical idea.

According to the communication system of the present invention, effects set forth in the following can be attained.

First effect is providing a means for realizing high reliability that is applicable to a network having various topology in which a plurality of communication media to which two base nodes communicating are connected include at least one relay node.

The reason is that the base node is allowed to assume a plurality of communication media as one node.

Second effect is providing a communication system having high reliability which enables communication to be continued even when a failure occurs.

The reason is that a failure is detected by transmitting and receiving a keep alive frame to continue communication using only a communication path in which no failure is detected.

Third effect is suppressing occurrence of congestion.

The reason is that a communication band can be expanded by executing communication using a plurality of communication paths.

Fourth effect is simple setting which enables reduction in a probability of erroneous setting.

The reason is that use of a keep alive frame having a specific destination address eliminates the need of setting of a destination address for each partner node.

Fifth effect is involving no drastic increase in load on a device even when the number of partner nodes is increased.

The reason is that broadcasting a keep alive frame by a relay node eliminates the need of transmission of a keep alive frame for each partner node.

1. A communication system in which three or more base nodes communicate through a plurality of communication media each formed of at least one relay node, wherein
said three or more base nodes include an assuming unit which handles a plurality of ports connected to said plurality of communication media among ports belonging to said base node as one virtual port to assume said plurality of communication media to be one node.

2. (canceled)

3. The communication system according to claim 1, wherein said assuming unit includes a forwarding data base which registers, for one destination, a plurality of pieces of forwarding information for transferring a data frame transmitted from a certain transmission source to a predetermined destination.

4. The communication system according to claim 1, wherein said assuming unit includes a port mapping table which correlates at least one port of said base node with one virtual port, and a forwarding data base which registers at least one said virtual port in forwarding information for transferring a data frame transmitted from a certain transmission source to a predetermined destination.

5-39. (canceled)

40. A node as a base communicating with each other through a plurality of communication media each formed of at least one relay node in a communication system, comprising an assuming unit which handles a plurality of ports connected to said plurality of communication media among ports belonging to each of three or more nodes as a base as one virtual port to assume said plurality of communication media to be one node.

41. The base node according to claim 40, wherein said assuming unit includes a forwarding data base which registers, for one destination, a plurality of pieces of forwarding information for transferring a data frame transmitted from a certain transmission source to a predetermined destination.

42. The base node according to claim 40, wherein said assuming unit includes a port mapping table which correlates at least one port of said base node with one virtual port, and a forwarding data base which registers at least one said virtual port in forwarding information for transferring a data frame transmitted from a certain transmission source to a predetermined destination.

43-65. (canceled)

66. A communication control program executed on a node as a base communicating with each other through a plurality of communication media each formed of at least one relay node in a communication system, which comprises
an assuming function of assuming said plurality of communication media to be one node by handling a plurality of ports connected to said plurality of communication media among ports belonging to each of three or more nodes as a base as one virtual port.

67. The communication control program according to claim 66, which comprises the function of registering, for one destination, a plurality of pieces of forwarding information for transferring a data frame transmitted from a certain transmission source to a predetermined destination in a forwarding data base.

68. The communication control program according to claim 66, which comprises the function of correlating at least one port of said base node with one virtual port in a port mapping table, and registering at least one said virtual port in forwarding information for transferring a data frame transmitted from a certain transmission source to a predetermined destination in a forwarding data base.

69. The communication control program according to claim 66, which comprises the function of, when transmitting a data frame to said communication medium having a different frame format, transmitting said data frame with header information of the frame format of said communication medium added and when receiving a data frame from said communication medium, receiving said data frame with the header information of the frame format of said communication medium removed.

70. The communication control program according to any one of claim 66 to claim 69, which comprises the function of transmitting and receiving a keep alive frame to/from each other to obtain a communication state of the communication system.

71. The communication control program according to claim 70, wherein said keep alive frame is broadcast by said relay node forming said plurality of communication media with a destination address recognized as unknown by said relay node forming said plurality of communication media recited.

72-88. (canceled)

89. A computer including a network interface card having the function of communicating with each other through a plurality of communication media each formed of at least one relay node in a communication system, wherein
said network interface card includes an assuming unit which handles a plurality of ports connected to said plurality of communication media among ports belonging to said network interface card three or more nodes as a base as one virtual port to assume said plurality of communication media to be one node.

90. The computer according to claim 89, wherein said assuming unit of said network interface card includes a forwarding data base which registers, for one destination, a plurality of pieces of forwarding information for transferring a data frame transmitted from a certain transmission source to a predetermined destination.

91. The computer according to claim 89, wherein said assuming unit of said network interface card includes a port mapping table which correlates at least one port with one virtual port, and a forwarding data base which registers at least one said virtual port in forwarding information for transferring a data frame transmitted from a certain transmission source to a predetermined destination.

92-113. (canceled)
